(19) United States
(12) Patent Application Publication
(10) Pub. No.: US 2026/0039358 A1
(43) Pub. Date: Feb. 5, 2026

(54) METHOD AND APPARATUS FOR MODULAR CHANNEL STATE INFORMATION REPORTING IN NEXT GENERATION WIRELESS COMMUNICATION NETWORKS

(71) Applicant: Samsung Electronics Co., Ltd., Suwon-si (KR)

(72) Inventors: Ameha Tsegaye ABEBE, Suwon-si (KR); Younsun KIM, Suwon-si (KR); Jaewon LEE, Suwon-si (KR); Youngrok JANG, Suwon-si (KR); Hyoungju JI, Suwon-si (KR); Youngbum KIM, Suwon-si (KR)

(21) Appl. No.: 19/288,461

(22) Filed: Aug. 1, 2025

(30) Foreign Application Priority Data
Aug. 1, 2024 (KR) 10-2024-0102560

(51) Int. Cl. H04B 7/06; H04L 41/16

(52) U.S. Cl. CPC H04B 7/0639; H04B 7/0626; H04L 41/16

(57) ABSTRACT

An apparatus and a method performed by a fifth generation (5G) or sixth generation (6G) communication system for supporting a higher data transmission rate are provided. A method performed by a user equipment (UE) in a communication system includes receiving first configuration information associated with codebook-based precoding matrix indicator (PMI) determination and second configuration information associated with artificial intelligence/machine learning (AI/ML)-based PMI determination; determining a first PMI component based on the first configuration information; transmitting the first PMI component; determining a second PMI component based on the second configuration information and an AI/ML model configured for the AI/ML-based PMI determination; and transmitting the second PMI component, wherein the second PMI component corresponds to a differential precoding matrix with respect to a precoding matrix corresponding to the first PMI component.

### CROSS-REFERENCE TO RELATED APPLICATION(S)

This application is based on and claims priority under 35 U.S.C. § 119 (a) of a Korean patent application number 10-2024-0102560, filed on Aug. 1, 2024, in the Korean Intellectual Property Office, the disclosure of which is incorporated by reference herein in its entirety.

### BACKGROUND

### 1. Field

The disclosure relates to the field of fifth generation (5G) and beyond 5G communication networks. More particularly, the disclosure relates to channel state information (CSI) feedback in multiple-input multiple-output (MIMO) system.

### 2. Description of Related Art

To meet the demand for wireless data traffic having increased since deployment of fourth generation (4G) communication systems, efforts have been made to develop an improved 5G or pre-5G communication system. Therefore, the 5G or pre-5G communication system is also called a ‘Beyond 4G Network’ or a ‘Post long term evolution (LTE) System’. The 5G communication system is considered to be implemented in higher frequency (millimeter-wave (mmWave)) bands, e.g., 60 gigahertz (GHz) bands, so as to accomplish higher data rates. To decrease propagation loss of the radio waves and increase the transmission distance, the beamforming, massive multiple-input multiple-output (MIMO), Full Dimensional MIMO (FD-MIMO), array antenna, an analog beam forming, large scale antenna techniques are discussed in 5G communication systems. In addition, in 5G communication systems, development for system network improvement is under way based on advanced small cells, cloud Radio Access Networks (RANs), ultra-dense networks, device-to-device (D2D) communication, wireless backhaul, moving network, cooperative communication, Coordinated Multi-Points (COMP), reception-end interference cancellation and the like. In the 5G system, hybrid frequency shift keying (FSK) and quadrature amplitude modulation (QAM) (FQAM) and sliding window superposition coding (SWSC) as an advanced coding modulation (ACM), and filter bank multi carrier (FBMC), non-orthogonal multiple access (NOMA), and sparse code multiple access (SCMA) as an advanced access technology have been developed.

The Internet, which is a human centered connectivity network where humans generate and consume information, is now evolving to the Internet of Things (IoT) where distributed entities, such as things, exchange and process information without human intervention. The Internet of Everything (IoE), which is a combination of the IoT technology and the Big Data processing technology through connection with a cloud server, has emerged. As technology elements, such as “sensing technology”, “wired/wireless communication and network infrastructure”, “service interface technology”, and “Security technology” have been demanded for IoT implementation, a sensor network, a Machine-to-Machine (M2M) communication, Machine Type Communication (MTC), and so forth have been recently researched. Such an IoT environment may provide intelligent Internet technology services that create a new value to human life by collecting and analyzing data generated among connected things. IoT may be applied to a variety of fields including smart home, smart building, smart city, smart car or connected cars, smart grid, health care, smart appliances and advanced medical services through convergence and combination between existing Information Technology (IT) and various industrial applications.

In line with this, various attempts have been made to apply 5G communication systems to IoT networks. For example, technologies such as a sensor network, Machine Type Communication (MTC), and Machine-to-Machine (M2M) communication may be implemented by beamforming, MIMO, and array antennas. Application of a cloud Radio Access Network (RAN) as the above-described Big Data processing technology may also be considered to be as an example of convergence between the 5G technology and the IoT technology.

The above information is presented as background information only to assist with an understanding of the disclosure. No determination has been made, and no assertion is made, as to whether any of the above might be applicable as prior art with regard to the disclosure.

### SUMMARY

Aspects of the disclosure are to address at least the above-mentioned problems and/or disadvantages and to provide at least the advantages described below. Accordingly, an aspect of the disclosure is to provide methods and apparatus for CSI reporting in communication networks, wherein the communication network is at least one of the Fifth Generation (5G) standalone network, a 5G non-standalone (NAS) network or Sixth Generation (6G) network.

Another aspect of the disclosure is to provide methods and systems to configure a user equipment (UE) with a CSI measurement and report, including, the precoding information, where the precoding information is configured to be reported in two components whereas the first component is derived from a predefined fixed codebook while the second component is generated by an artificial intelligence/machine learning (AI/ML) model.

Additional aspects will be set forth in part in the description which follows and, in part, will be apparent from the description, or may be learned by practice of the presented embodiments.

In accordance with an aspect of the disclosure, a method performed by a user equipment (UE) in a communication system includes receiving first configuration information associated with codebook-based precoding matrix indicator (PMI) determination and second configuration information associated with artificial intelligence/machine learning (AI/ML)-based PMI determination; determining a first PMI component based on the first configuration information; transmitting the first PMI component; determining a second PMI component based on the second configuration information and an AI/ML model configured for the AI/ML-based PMI determination; and transmitting the second PMI component, wherein the second PMI component corresponds to a differential precoding matrix with respect to a precoding matrix corresponding to the first PMI component.

In accordance with an aspect of the disclosure, wherein the first PMI component is determined based on a number of ports for the first PMI component and the second PMI component is determined based on a number of ports for the second PMI component, and wherein: the number of ports for the first PMI component is identified based on the first configuration information, and the number of ports for the second PMI component is identified based on the number of ports for the first PMI component and a port scaling factor to scale the number of ports for the first PMI component, wherein the port scaling factor is configured based on the second configuration information, or (i) in case that the number of ports for the second PMI component is explicitly configured based on the second configuration information, the number of ports for the second PMI component is the configured number, and in case that the number of ports for the second PMI component is not explicitly configured, the number of ports for the second PMI component is identical to a number of ports for channel state information (CSI) reference signal, and (ii) the number of ports for the first PMI component is identified based on a bitmap based port indicator to indicate ports for the first PMI component among the number of ports for the second PMI component, wherein the bitmap based port indicator is configured based on the first configuration information.

In accordance with an aspect of the disclosure, wherein the first PMI component is determined based on a first number of subbands and the second PMI component is determined based on a second number of subbands, wherein: the number of subbands for the first PMI component is identified based on the first configuration information, and the number of subbands for the second PMI component is identified based on the number of subbands for the first PMI component and a subband scaling factor to scale the number of subbands for the first PMI component, wherein the subband scaling factor is configured based on the second configuration information, or the number of subbands for the second PMI component is identified based on the second configuration information, and the number of subbands for the first PMI component is identified based on a bitmap based subband indicator to indicate subbands for the first PMI component among the subbands for the CSI reference signal, wherein the bitmap based subband indicator is configured based on the first configuration information.

In accordance with an aspect of the disclosure, wherein information on first combining coefficients corresponding to the first PMI component is transmitted with the first PMI component and information on second combining coefficients corresponding to the second PMI component is transmitted with the second PMI component, wherein the first combining coefficients are determined based on the first configuration information and the second combining coefficients are determined based on the second configuration information and the AI/ML model, and wherein the second combining coefficients correspond to delta values with respect to the first combining coefficients.

In accordance with an aspect of the disclosure, wherein in case that the UE is not configured to report channel quality indicator (CQI) in one component, the CQI is determined based on an aggregation of the precoding matrix corresponding to the first PMI component and the differential precoding matrix corresponding to the second PMI component, and wherein in case that the UE is configured to report the CQI in two components, a first CQI component is determined based on the precoding matrix corresponding to first PMI component and a second CQI component corresponds to a differential CQI between the CQI determined based on the aggregation of the precoding matrix corresponding to the first PMI component and the differential precoding matrix corresponding to the second PMI component and the first CQI component.

In accordance with an aspect of the disclosure, wherein the first PMI component is transmitted once for N transmissions of the second PMI component.

In accordance with an aspect of the disclosure, a user equipment (UE) in a communication system includes a transceiver; and a processor coupled with the transceiver and configured to: receive first configuration information associated with codebook-based precoding matrix indicator (PMI) determination and second configuration information associated with artificial intelligence/machine learning (AI/ML)-based PMI determination; determine a first PMI component based on the first configuration information; transmit the first PMI component; determine a second PMI component based on the second configuration information and an AI/ML model configured for the AI/ML-based PMI determination; and transmit the second PMI component, wherein the second PMI component corresponds to a differential precoding matrix with respect to a precoding matrix corresponding to the first PMI component.

In accordance with an aspect of the disclosure, wherein the first PMI component is determined based on a number of ports for the first PMI component and the second PMI component is determined based on a number of ports for the second PMI component, and wherein: the number of ports for the first PMI component is identified based on the first configuration information, and the number of ports for the second PMI component is identified based on the number of ports for the first PMI component and a port scaling factor to scale the number of ports for the first PMI component, wherein the port scaling factor is configured based on the second configuration information, or (i) in case that the number of ports for the second PMI component is explicitly configured based on the second configuration information, the number of ports for the second PMI component is the configured number, and in case that the number of ports for the second PMI component is not explicitly configured, the number of ports for the second PMI component is identical to a number of ports for channel state information (CSI) reference signal, and (ii) the number of ports for the first PMI component is identified based on a bitmap based port indicator to indicate ports for the first PMI component among the number of ports for the second PMI component, wherein the bitmap based port indicator is configured based on the first configuration information.

In accordance with an aspect of the disclosure, wherein the first PMI component is determined based on a first number of subbands and the second PMI component is determined based on a second number of subbands, wherein: the number of subbands for the first PMI component is identified based on the first configuration information, and the number of subbands for the second PMI component is identified based on the number of subbands for the first PMI component and a subband scaling factor to scale the number of subbands for the first PMI component, wherein the subband scaling factor is configured based on the second configuration information, or the number of subbands for the second PMI component is identified based on the second configuration information, and the number of subbands for the first PMI component is identified based on a bitmap based subband indicator to indicate subbands for the first PMI component among the subbands for the CSI reference signal, wherein the bitmap based subband indicator is configured based on the first configuration information.

In accordance with an aspect of the disclosure, wherein information on first combining coefficients corresponding to the first PMI component is transmitted with the first PMI component and information on second combining coefficients corresponding to the second PMI component is transmitted with the second PMI component, wherein the first combining coefficients are determined based on the first configuration information and the second combining coefficients are determined based on the second configuration information and the AI/ML model, and wherein the second combining coefficients correspond to delta values with respect to the first combining coefficients.

In accordance with an aspect of the disclosure, wherein in case that the UE is not configured to report channel quality indicator (CQI) in one component, the CQI is determined based on an aggregation of the precoding matrix corresponding to the first PMI component and the differential precoding matrix corresponding to the second PMI component, and wherein in case that the UE is configured to report the CQI in two components, a first CQI component is determined based on the precoding matrix corresponding to first PMI component and a second CQI component corresponds to a differential CQI between the CQI determined based on the aggregation of the precoding matrix corresponding to the first PMI component and the differential precoding matrix corresponding to the second PMI component and the first CQI component.

In accordance with an aspect of the disclosure, wherein the first PMI component is transmitted once for N transmissions of the second PMI component.

In accordance with an aspect of the disclosure, a method performed by a base station in a communication system includes transmitting first configuration information associated with codebook-based precoding matrix indicator (PMI) determination and second configuration information associated with artificial intelligence/machine learning (AI/ML)-based PMI determination; receiving a first PMI component associated with the first configuration information; and receiving a second PMI component associated with the second configuration information and an AI/ML model configured for the AI/ML-based PMI determination, wherein the second PMI component corresponds to a differential precoding matrix with respect to a precoding matrix corresponding to the first PMI component.

In accordance with an aspect of the disclosure, wherein the first PMI component is based on a number of ports for the first PMI component and the second PMI component is determined based on a number of ports for the second PMI component, and wherein: the number of ports for the first PMI component is indicated based on the first configuration information, and the number of ports for the second PMI component is indicated based on the number of ports for the first PMI component and a port scaling factor to scale the number of ports for the first PMI component, wherein the port scaling factor is configured based on the second configuration information, or (i) in case that the number of ports for the second PMI component is explicitly configured based on the second configuration information, the number of ports for the second PMI component is the configured number, and in case that the number of ports for the second PMI component is not explicitly configured, the number of ports for the second PMI component is identical to a number of ports for channel state information (CSI) reference signal, and (ii) the number of ports for the first PMI component is indicated based on a bitmap based port indicator to indicate ports for the first PMI component among the number of ports for the second PMI component, wherein the bitmap based port indicator is configured based on the first configuration information.

In accordance with an aspect of the disclosure, wherein the first PMI component is based on a first number of subbands and the second PMI component is based on a second number of subbands, wherein: the number of subbands for the first PMI component is indicated based on the first configuration information, and the number of subbands for the second PMI component is indicated based on the number of subbands for the first PMI component and a subband scaling factor to scale the number of subbands for the first PMI component, wherein the subband scaling factor is configured based on the second configuration information, or the number of subbands for the second PMI component is indicated based on the second configuration information, and the number of subbands for the first PMI component is indicated based on a bitmap based subband indicator to indicate subbands for the first PMI component among the subbands for the CSI reference signal, wherein the bitmap based subband indicator is configured based on the first configuration information.

In accordance with an aspect of the disclosure, wherein information on first combining coefficients corresponding to the first PMI component is received with the first PMI component and information on second combining coefficients corresponding to the second PMI component is received with the second PMI component, wherein the first combining coefficients are based on the first configuration information and the second combining coefficients are based on the second configuration information and the AI/ML model, and wherein the second combining coefficients correspond to delta values with respect to the first combining coefficients.

In accordance with an aspect of the disclosure, a base station in a communication system includes a transceiver; and a processor coupled with the transceiver and configured to: transmit first configuration information associated with codebook-based precoding matrix indicator (PMI) determination and second configuration information associated with artificial intelligence/machine learning (AI/ML)-based PMI determination; receive a first PMI component associated with the first configuration information; and receive a second PMI component associated with the second configuration information and an AI/ML model configured for the AI/ML-based PMI determination, wherein the second PMI component corresponds to a differential precoding matrix with respect to a precoding matrix corresponding to the first PMI component.

In accordance with an aspect of the disclosure, wherein the first PMI component is based on a number of ports for the first PMI component and the second PMI component is determined based on a number of ports for the second PMI component, and wherein: the number of ports for the first PMI component is indicated based on the first configuration information, and the number of ports for the second PMI component is indicated based on the number of ports for the first PMI component and a port scaling factor to scale the number of ports for the first PMI component, wherein the port scaling factor is configured based on the second configuration information, or (i) in case that the number of ports for the second PMI component is explicitly configured based on the second configuration information, the number of ports for the second PMI component is the configured number, and in case that the number of ports for the second PMI component is not explicitly configured, the number of ports for the second PMI component is identical to a number of ports for channel state information (CSI) reference signal, and (ii) the number of ports for the first PMI component is indicated based on a bitmap based port indicator to indicate ports for the first PMI component among the number of ports for the second PMI component, wherein the bitmap based port indicator is configured based on the first configuration information.

In accordance with an aspect of the disclosure, wherein the first PMI component is based on a first number of subbands and the second PMI component is based on a second number of subbands, wherein: the number of subbands for the first PMI component is indicated based on the first configuration information, and the number of subbands for the second PMI component is indicated based on the number of subbands for the first PMI component and a subband scaling factor to scale the number of subbands for the first PMI component, wherein the subband scaling factor is configured based on the second configuration information, or the number of subbands for the second PMI component is indicated based on the second configuration information, and the number of subbands for the first PMI component is indicated based on a bitmap based subband indicator to indicate subbands for the first PMI component among the subbands for the CSI reference signal, wherein the bitmap based subband indicator is configured based on the first configuration information.

In accordance with an aspect of the disclosure, wherein information on first combining coefficients corresponding to the first PMI component is received with the first PMI component and information on second combining coefficients corresponding to the second PMI component is received with the second PMI component, wherein the first combining coefficients are based on the first configuration information and the second combining coefficients are based on the second configuration information and the AI/ML model, and wherein the second combining coefficients correspond to delta values with respect to the first combining coefficients.

Other aspects, advantages, and salient features of the disclosure will become apparent to those skilled in the art from the following detailed description, which, taken in conjunction with the annexed drawings, discloses various embodiments of the disclosure.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 illustrates an example wireless network according to an embodiment of the disclosure;

FIG. 2A illustrates an example wireless transmit path according to various embodiments of the disclosure;

FIG. 2B illustrates an example wireless receive path according to various embodiments of the disclosure;

FIG. 3A illustrates an example user equipment (UE) according to various embodiments of the disclosure;

FIG. 3B illustrates an example gNB, respectively according to various embodiments of the disclosure;

FIG. 4 illustrates cross-polarized MIMO antenna system according to an embodiment of the disclosure;

FIG. 5 illustrates layout for channel state information reference signal (CSI-RS) resource mapping in an orthogonal frequency division multiple access (OFDMA) time-frequency grid according to an embodiment of the disclosure;

FIG. 6 illustrates an example of precoder construction in Type II CSI according to an embodiment of the disclosure;

FIG. 7A illustrates reporting precoding matrices in subband granularity according to an embodiment of the disclosure;

FIG. 7B illustrates a precoding matrix construction for enhanced Type II CSI according to an embodiment of the disclosure;

FIG. 8 illustrates an autoencoder based CSI feedback according to an embodiment of the disclosure;

FIG. 9 depicts an embodiment for an autoencoder based CSI feedback wherein a preprocessing unit transforms the estimated channel to stacked eigenvectors according to an embodiment of the disclosure;

FIG. 10 illustrates procedure for switching to and from AI/ML-based CSI feedback and codebook-based CSI feedback according to an embodiment of the disclosure;

FIG. 11 illustrates two approaches for the co-configuration of AI/ML-based CSI feedback and codebook-based CSI feedback according to an embodiment of the disclosure;

FIG. 12 illustrates antenna ports configuration for AI/ML-based CSI feedback and codebook-based CSI feedback according to an embodiment of the disclosure;

FIG. 13 illustrates indication for uneven subbands mapping of a CSI report configuration with two precoding matrix indicator (PMI) components according to an embodiment of the disclosure;

FIG. 14 illustrates indication for equally-spaced subbands mapping of a CSI report configuration with two PMI components according to an embodiment of the disclosure;

FIG. 15 illustrates channel quality indicator (CQI) determination consideration according to an embodiment of the disclosure;

FIG. 16 illustrates a yet another CQI determination consideration according to an embodiment of the disclosure; and

FIG. 17 illustrates periodic and semi-persistent configuration with different periodicity for two PMI components according to an embodiment of the disclosure.

Throughout the drawings, it should be noted that like reference numbers are used to depict the same or similar elements, features, and structures.

### DETAILED DESCRIPTION

The following description with reference to the accompanying drawings is provided to assist in a comprehensive understanding of various embodiments of the disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the disclosure. Accordingly, it should be apparent to those skilled in the art that the following description of various embodiments of the disclosure is provided for illustration purpose only and not for the purpose of limiting the disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

Wireless communication has been one of the most successful innovations in modern history. Recently, the number of subscribers to wireless communication services exceeded five billion and continues to grow quickly. The demand of wireless data traffic is rapidly increasing due to the growing popularity among consumers and businesses of smart phones and other mobile data devices, such as tablets, “note pad” computers, net books, eBook readers, and machine type of devices. As such, in order to meet the high growth in mobile data traffic and support new applications and deployments, improvements in radio interface efficiency and coverage is of paramount importance.

To meet the demand for wireless data traffic having increased since deployment of 4G communication systems, and to enable various vertical applications, 5G communication systems have been developed and are currently being deployed.

The 5G communication system is considered to be implemented to include higher frequency (mmWave) bands, such as 28 GHz or 60 GHz bands or, in general, above 6 GHz bands, so as to accomplish higher data rates, or in lower frequency bands, such as below 6 GHZ, to enable robust coverage and mobility support. Aspects of the disclosure may be applied to deployment of 5G communication systems, 6G or even later releases which may use THz bands. To decrease propagation loss of the radio waves and increase the transmission distance, the beamforming, massive multiple-input multiple-output (MIMO), Full Dimensional MIMO (FD-MIMO), array antenna, an analog beam forming, large-scale antenna techniques are discussed in 5G communication systems.

In addition, in 5G communication systems, development for system network improvement is under way based on advanced small cells, cloud Radio Access Networks (RANs), ultra-dense networks, device-to-device (D2D) communication, wireless backhaul, moving network, cooperative communication, Coordinated Multi-Points (COMP), reception-end interference cancellation and the like.

It should be appreciated that the blocks in each flowchart and combinations of the flowcharts may be performed by one or more computer programs which include instructions. The entirety of the one or more computer programs may be stored in a single memory device or the one or more computer programs may be divided with different portions stored in different multiple memory devices.

Any of the functions or operations described herein can be processed by one processor or a combination of processors. The one processor or the combination of processors is circuitry performing processing and includes circuitry like an application processor (AP, e.g. a central processing unit (CPU)), a communication processor (CP, e.g., a modem), a graphics processing unit (GPU), a neural processing unit (NPU) (e.g., an artificial intelligence (AI) chip), a wireless fidelity (Wi-Fi) chip, a Bluetooth® chip, a global positioning system (GPS) chip, a near field communication (NFC) chip, connectivity chips, a sensor controller, a touch controller, a finger-print sensor controller, a display driver integrated circuit (IC), an audio CODEC chip, a universal serial bus (USB) controller, a camera controller, an image processing IC, a microprocessor unit (MPU), a system on chip (SoC), an IC, or the like.

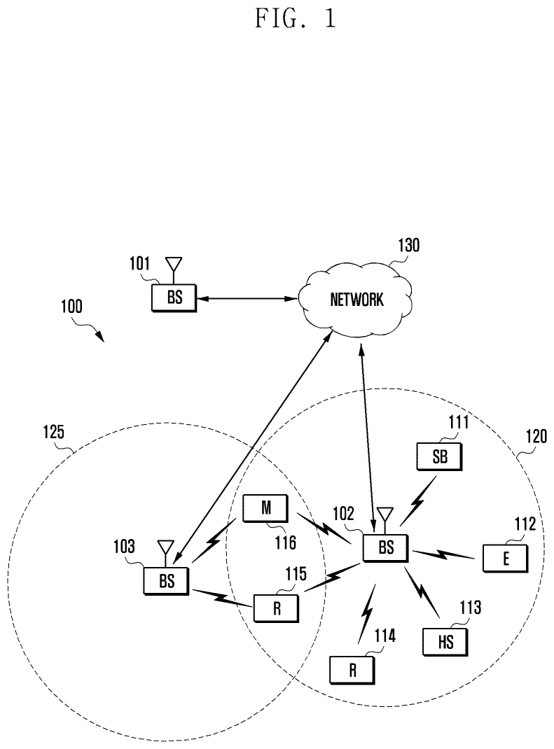

FIG. 1 illustrates an example wireless network 100 according to an embodiment of the disclosure.

The embodiment of the wireless network 100 shown in FIG. 1 is for illustration only. Other embodiments of the wireless network 100 can be used without departing from the scope of this disclosure.

The wireless network 100 includes an gNodeB (gNB) 101, an gNB 102, and an gNB 103. The gNB 101 communicates with the gNB 102 and the gNB 103. The gNB 101 also communicates with at least one Internet Protocol (IP) network 130, such as the Internet, a proprietary IP network, or other data network.

Depending on the network type, the term ‘gNB’ can refer to any component (or collection of components) configured to provide remote terminals with wireless access to a network, such as base transceiver station, a radio base station, transmit point (TP), transmit-receive point (TRP), a ground gateway, an airborne gNB, a satellite system, mobile base station, a macrocell, a femtocell, a WiFi access point (AP) and the like. Depending on the network type, other well-known terms may be used instead of “user equipment” or “UE,” such as “mobile station,” “subscriber station,” “remote terminal,” “wireless terminal,” or “user device.” For the sake of convenience, the terms “user equipment” and “UE” are used in this patent document to refer to equipment that wirelessly accesses a gNB. The UE could be a mobile device or a stationary device. For example, UE could be a mobile telephone, smartphone, monitoring device, alarm device, fleet management device, asset tracking device, automobile, desktop computer, entertainment device, infotainment device, vending machine, electricity meter, water meter, gas meter, security device, sensor device, appliance etc.

The gNB 102 provides wireless broadband access to the network 130 for a first plurality of user equipments (UEs) within a coverage area 120 of the gNB 102. The first plurality of UEs includes a UE 111, which may be located in a small business (SB); a UE 112, which may be located in an enterprise (E); a UE 113, which may be located in a WiFi hotspot (HS); a UE 114, which may be located in a first residence (R); a UE 115, which may be located in a second residence (R); and a UE 116, which may be a mobile device (M) like a cell phone, a wireless laptop, a wireless personal digital assistant (PDA), or the like. The gNB 103 provides wireless broadband access to the network 130 for a second plurality of UEs within a coverage area 125 of the gNB 103. The second plurality of UEs includes the UE 115 and the UE 116. In some embodiments, one or more of the gNBs 101-103 may communicate with each other and with the UEs 111-116 using 5G, long-term evolution (LTE), LTE-advanced (LTE-A), WiMAX, or other advanced wireless communication techniques.

Dotted lines show the approximate extents of the coverage areas 120 and 125, which are shown as approximately circular for the purposes of illustration and explanation only. It should be clearly understood that the coverage areas associated with gNBs, such as the coverage areas 120 and 125, may have other shapes, including irregular shapes, depending upon the configuration of the gNBs and variations in the radio environment associated with natural and man-made obstructions.

As described in more detail below, one or more of BS 101, BS 102 and BS 103 include two-dimensional (2D) antenna arrays as described in embodiments of the disclosure. In some embodiments, one or more of BS 101, BS 102 and BS 103 support the codebook design and structure for systems having 2D antenna arrays.

Although FIG. 1 illustrates one example of a wireless network 100, various changes may be made to FIG. 1. For example, the wireless network 100 can include any number of gNBs and any number of UEs in any suitable arrangement. Also, the gNB 101 can communicate directly with any number of UEs and provide those UEs with wireless broadband access to the network 130. Similarly, each gNB 102-103 can communicate directly with the network 130 and provide UEs with direct wireless broadband access to the network 130. Further, the gNB 101, 102, and/or 103 can provide access to other or additional external networks, such as external telephone networks or other types of data networks.

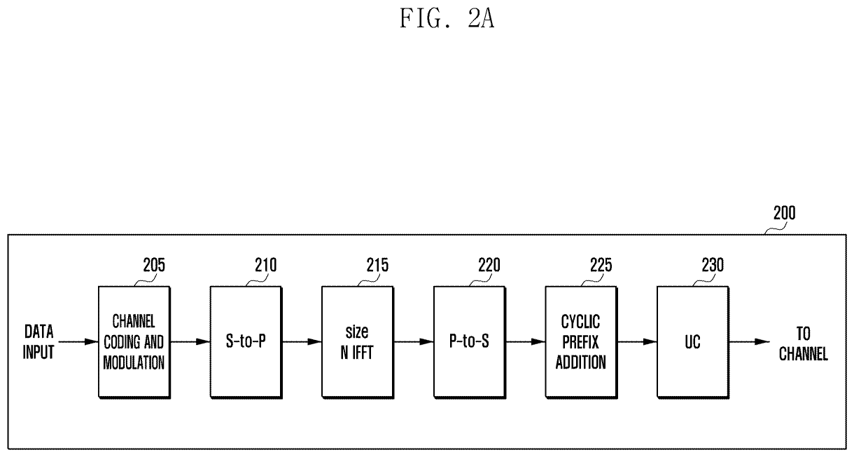

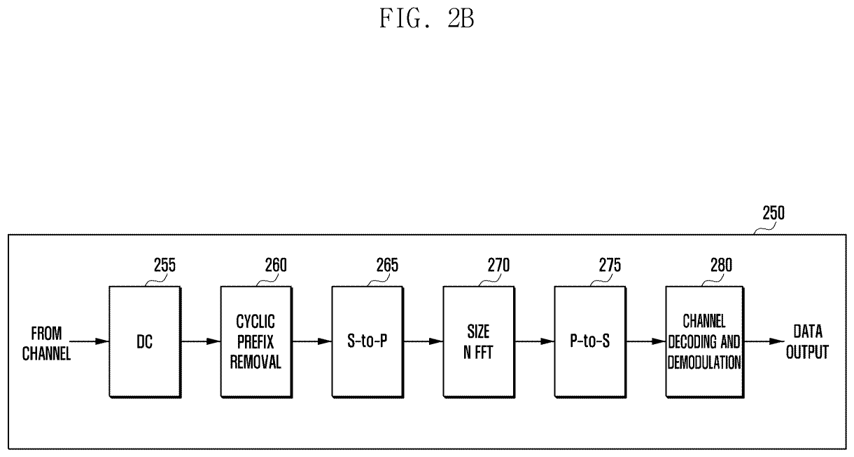

FIGS. 2A and 2B illustrate example wireless transmit and receive paths according to various embodiments of the disclosure.

In the following description, a transmit path 200 may be described as being implemented in an gNB (such as gNB 102), while a receive path 250 may be described as being implemented in a UE (such as UE 116). However, it will be understood that the receive path 250 can be implemented in an gNB and that the transmit path 200 can be implemented in a UE. In some embodiments, the receive path 250 is configured to support the codebook design and structure for systems having 2D antenna arrays as described in embodiments of the disclosure.

The transmit path 200 includes a channel coding and modulation block 205, a serial-to-parallel (S-to-P) block 210, a size N Inverse Fast Fourier Transform (IFFT) block 215, a parallel-to-serial (P-to-S) block 220, an add cyclic prefix block 225, and an up-converter (UC) 230. The receive path 250 includes, for example, a down-converter (DC) 255, a remove cyclic prefix block 260, a serial-to-parallel (S-to-P) block 265, a size N Fast Fourier Transform (FFT) block 270, a parallel-to-serial (P-to-S) block 275, and a channel decoding and demodulation block 280.

In the transmit path 200, the channel coding and modulation block 205 receives a set of information bits, applies coding (such as a low-density parity check (LDPC) coding), and modulates the input bits (such as with Quadrature Phase Shift Keying (QPSK) or Quadrature Amplitude Modulation (QAM)) to generate a sequence of frequency-domain modulation symbols. The serial-to-parallel block 210 converts (such as de-multiplexes) the serial modulated symbols to parallel data in order to generate N parallel symbol streams, where N is the IFFT/FFT size used in the gNB 102 and the UE 116. The size N IFFT block 215 performs an IFFT operation on the N parallel symbol streams to generate time-domain output signals. In an embodiment, the parallel-to-serial block 220 converts (such as multiplexes) the parallel time-domain output symbols from the size N IFFT block 215 in order to generate a serial time-domain signal. The add cyclic prefix block 225 inserts a cyclic prefix to the time-domain signal. The up-converter 230 modulates (such as up-converts) the output of the add cyclic prefix block 225 to a radio frequency (RF) for transmission via a wireless channel. The signal may also be filtered at baseband before conversion to the RF frequency.

A transmitted RF signal from the gNB 102 arrives at the UE 116 after passing through the wireless channel, and reverse operations to those at the gNB 102 are performed at the UE 116. The down-converter 255 down-converts the received signal to a baseband frequency, and the remove cyclic prefix block 260 removes the cyclic prefix to generate a serial time-domain baseband signal. The serial-to-parallel block 265 converts, for example, the time-domain baseband signal to parallel time domain signals. The size N FFT block 270 performs an FFT algorithm to generate N parallel frequency-domain signals. The parallel-to-serial block 275 converts the parallel frequency-domain signals to a sequence of modulated data symbols. The channel decoding and demodulation block 280 demodulates and decodes the modulated symbols to recover the original input data stream.

Each of the gNBs 101-103 may implement a transmit path 200 that is analogous to transmitting in the downlink to UEs 111-116 and may implement a receive path 250 that is analogous to receiving in the uplink from UEs 111-116. Each of UEs 111-116 may implement a transmit path 200 for transmitting in the uplink to gNBs 101- 103 and may implement a receive path 250 for receiving in the downlink from gNBs 101-103.

Each of the components in FIGS. 2A and 2B can be implemented using only hardware or using a combination of hardware and software/firmware. As a particular example, at least some of the components in FIGS. 2A and 2B may be implemented in software, while other components may be implemented by configurable hardware or a mixture of software and configurable hardware. For instance, the FFT block 270 and the IFFT block 215 may be implemented as configurable software algorithms, where the value of size N may be modified according to the implementation.

Although described as using FFT and IFFT, this is by way of illustration only and should not be construed to limit the scope of this disclosure. Other types of transforms, such as Discrete Fourier Transform (DFT) and Inverse Discrete Fourier Transform (IDFT) functions, can be used. It will be appreciated that the value of the variable N may be any integer number (such as 1, 2, 3, 4, or the like) for DFT and IDFT functions, while the value of the variable N may be any integer number that is a power of two (such as 1, 2, 4, 8, 16, or the like) for FFT and IFFT functions.

Although FIGS. 2A and 2B illustrate examples of wireless transmit and receive paths, various changes may be made to FIGS. 2A and 2B. For example, various components in FIGS. 2A and 2B can be combined, further subdivided, or omitted and additional components can be added according to particular needs. Also, FIGS. 2A and 2B are meant to illustrate examples of the types of transmit and receive paths that can be used in a wireless network. Any other suitable architectures can be used to support wireless communications in a wireless network.

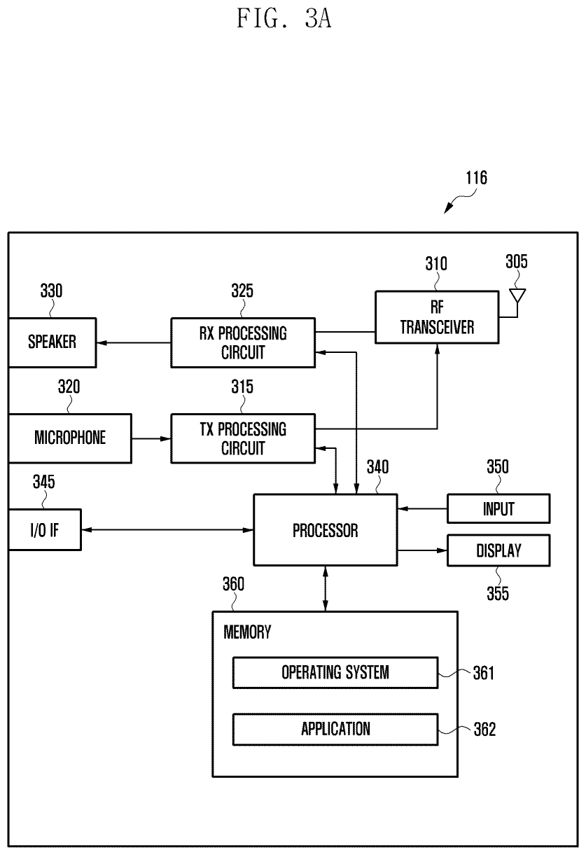

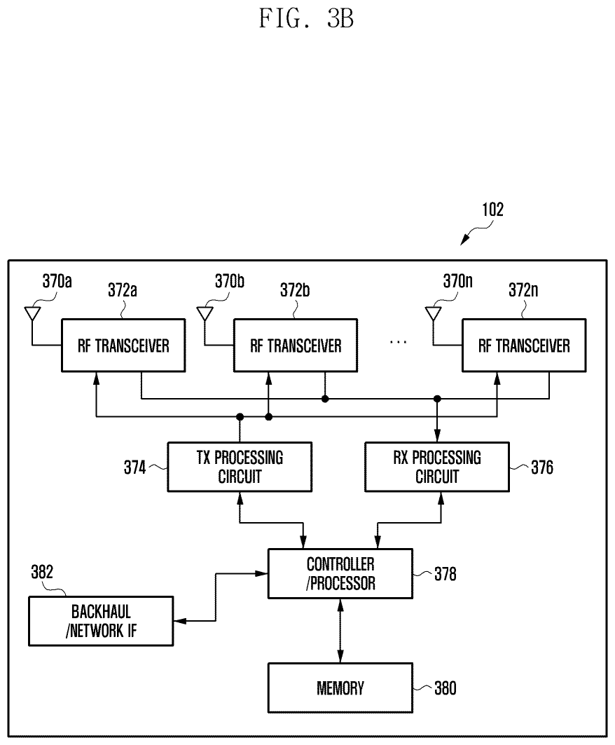

FIG. 3A illustrates an example UE 116 according to an embodiment of the disclosure.

The embodiment of the UE 116 illustrated in FIG. 3A is for illustration only, and the UEs 111-115 of FIG. 1 can have the same or similar configuration. However, UEs come in a wide variety of configurations, and FIG. 3A does not limit the scope of this disclosure to any particular implementation of a UE.

The UE 116 includes an antenna 305, a radio frequency (RF) transceiver 310, transmit (TX) processing circuitry 315, a microphone 320, and receive (RX) processing circuitry 325. The UE 116 also includes a speaker 330, a main processor 340, an input/output (I/O) interface (IF) 345, a keypad 350, a display 355, and a memory 360. The memory 360 includes a basic operating system (OS) program 361 and one or more applications 362.

In an embodiment, the RF transceiver 310 receives, from the antenna 305, an incoming RF signal transmitted by an gNB of the network 100. The RF transceiver 310 down-converts the incoming RF signal to generate an intermediate frequency (IF) or baseband signal. The IF or baseband signal is sent to the RX processing circuitry 325, which generates a processed baseband signal by filtering, decoding, and/or digitizing the baseband or IF signal. The RX processing circuitry 325 transmits the processed baseband signal to the speaker 330 (such as for voice data) or to the main processor 340 for further processing (such as for web browsing data).

The TX processing circuitry 315 receives, for example, analog or digital voice data from the microphone 320 or other outgoing baseband data (such as web data, e-mail, or interactive video game data) from the main processor 340. The TX processing circuitry 315 encodes, multiplexes, and/or digitizes the outgoing baseband data to generate a processed baseband or IF signal. The RF transceiver 310 receives the outgoing processed baseband or IF signal from the TX processing circuitry 315 and up-converts the baseband or IF signal to an RF signal that is transmitted via the antenna 305.

The main processor 340 can include one or more processors or other processing devices and execute the basic OS program 361 stored in the memory 360 in order to control the overall operation of the UE 116. In an example, the main processor 340 can control the reception of forward channel signals and the transmission of reverse channel signals by the RF transceiver 310, the RX processing circuitry 325, and the TX processing circuitry 315 in accordance with well-known principles. In some embodiments, the main processor 340 includes at least one microprocessor or microcontroller.

The main processor 340 is also capable of executing other processes and programs resident in the memory 360, such as operations for channel quality measurement and reporting for systems having 2D antenna arrays as described in embodiments of the disclosure as described in embodiments of the disclosure. The main processor 340 can move data into or out of the memory 360 as required by an executing process. In various embodiments, the main processor 340 is configured to execute the applications 362 based on the OS program 361 or in response to signals received from gNBs or an operator. The main processor 340 is also coupled to the I/O interface 345, which provides the UE 116 with the ability to connect to other devices such as laptop computers and handheld computers. The I/O interface 345 is the communication path between these accessories and the main controller 340.

The main processor 340 is also coupled to the keypad 350 and the display unit 355. The operator of the UE 116 can use the keypad 350 to enter data into the UE 116. The display 355 may be a liquid crystal display or other display capable of rendering text and/or at least limited graphics, such as from web sites. The memory 360 is coupled to the main processor 340. Part of the memory 360 can include a random access memory (RAM), and another part of the memory 360 can include a Flash memory or other read-only memory (ROM).

Although FIG. 3A illustrates one example of UE 116, various changes may be made to FIG. 3A. For example, various components in FIG. 3A can be combined, further subdivided, or omitted and additional components can be added according to particular needs. As a particular example, the main processor 340 can be divided into multiple processors, such as one or more central processing units (CPUs) and one or more graphics processing units (GPUs). Also, while FIG. 3A illustrates the UE 116 configured as a mobile telephone or smartphone, UEs can be configured to operate as other types of mobile or stationary devices.

FIG. 3B illustrates an example gNB 102 according to an embodiment of the disclosure.

The embodiment of the gNB 102 shown in FIG. 3B is for illustration only, and other gNBs of FIG. 1 can have the same or similar configuration. However, gNBs come in a wide variety of configurations, and FIG. 3B does not limit the scope of this disclosure to any particular implementation of an gNB. It is noted that gNB 101 and gNB 103 can include the same or similar structure as gNB 102.

Referring to FIG. 3B, the gNB 102 includes multiple antennas 370a, 370b, . . . 370n, multiple RF transceivers 372a, 372b, . . . 372n, transmit (TX) processing circuitry 374, and receive (RX) processing circuitry 376. In certain embodiments, one or more of the multiple antennas 370a, 370b, . . . 370n include 2D antenna arrays. The gNB 102 also includes a controller/processor 378, a memory 380, and a backhaul or network interface 382.

The RF transceivers 372a, 372b, . . . 372n receive, from the antennas 370a, 370b, . . . 370n, incoming RF signals, such as signals transmitted by UEs or other gNBs. The RF transceivers 372a, 372b, . . . 372n down-convert the incoming RF signals to generate IF or baseband signals. The IF or baseband signals are sent to the RX processing circuitry 376, which generates processed baseband signals by filtering, decoding, and/or digitizing the baseband or IF signals. The RX processing circuitry 376 transmits the processed baseband signals to the controller/processor 378 for further processing.

The TX processing circuitry 374 receives analog or digital data (such as voice data, web data, e-mail, or interactive video game data) from the controller/processor 378. The TX processing circuitry 374 encodes, multiplexes, and/or digitizes the outgoing baseband data to generate processed baseband or IF signals. The RF transceivers 372a, 372b, . . . 372n receive the outgoing processed baseband or IF signals from the TX processing circuitry 374 and up-converts the baseband or IF signals to RF signals that are transmitted via the antennas 370a, 370b, . . . 370n.

In an embodiment, the controller/processor 378 can include one or more processors or other processing devices that control the overall operation of the gNB 102. For example, the controller/processor 378 can control the reception of forward channel signals and the transmission of reverse channel signals by the RF transceivers 372a, 372b, . . . 372n, the RX processing circuitry 376, and the TX processing circuitry 374 in accordance with well-known principles. The controller/processor 378 can support additional functions as well, such as more advanced wireless communication functions. For instance, the controller/processor 378 can perform the blind interference sensing (BIS) process, such as performed by a BIS algorithm, and decodes the received signal subtracted by the interfering signals. Any of a wide variety of other functions can be supported in the gNB 102 by the controller/processor 378. In some embodiments, the controller/processor 378 includes at least one microprocessor or microcontroller.

The controller/processor 378 is also capable of executing programs and other processes resident in the memory 380, such as a basic OS. The controller/processor 378 is also capable of supporting channel quality measurement and reporting for systems having 2D antenna arrays as described in embodiments of the disclosure. In some embodiments, the controller/processor 378 supports communications between entities, such as web real-time communication (RTC). The controller/processor 378 can move data into or out of the memory 380 as required by an executing process.

The controller/processor 378 is also coupled to the backhaul or network interface 382. The backhaul or network interface 382 allows the gNB 102 to communicate with other devices or systems over a backhaul connection or over a network. The interface 382 can support communications over any suitable wired or wireless connection(s). In an example, when the gNB 102 is implemented as part of a cellular communication system (such as one supporting 5G, LTE, or LTE-A), the interface 382 can allow the gNB 102 to communicate with other gNBs over a wired or wireless backhaul connection. When the gNB 102 is implemented as an access point, the interface 382 can allow the gNB 102 to communicate over a wired or wireless local area network or over a wired or wireless connection to a larger network (such as the Internet). The interface 382 includes any suitable structure supporting communications over a wired or wireless connection, such as an Ethernet or RF transceiver.

The memory 380 is coupled to the controller/processor 378. Part of the memory 380 can include a RAM, and another part of the memory 380 can include a Flash memory or other ROM. In certain embodiments, a plurality of instructions, such as a BIS algorithm is stored in memory. The plurality of instructions are configured to cause, for example, the controller/processor 378 to perform the BIS process and to decode a received signal after subtracting out at least one interfering signal determined by the BIS algorithm.

As described in more detail below, the transmit and receive paths of the gNB 102 (implemented using the RF transceivers 372a, 372b, . . . 372n, TX processing circuitry 374, and/or RX processing circuitry 376) support communication with aggregation of frequency-domain duplexing (FDD) cells and time-domain duplexing (TDD) cells.

Although FIG. 3B illustrates one example of a gNB 102, various changes may be made to FIG. 3B. For example, the gNB 102 can include any number of each component shown in FIG. 3B. As a particular example, an access point can include a number of interfaces 382, and the controller/processor 378 can support routing functions to route data between different network addresses. As another particular example, while shown as including a single instance of TX processing circuitry 374 and a single instance of RX processing circuitry 376, the gNB 102 can include multiple instances of each (such as one per RF transceiver).

Multiple input multiple output (MIMO) system wherein a BS and/or a UE is equipped with multiple antennas has been widely employed in wireless systems for its advantages in terms of spatial multiplexing, diversity gain and array gain.

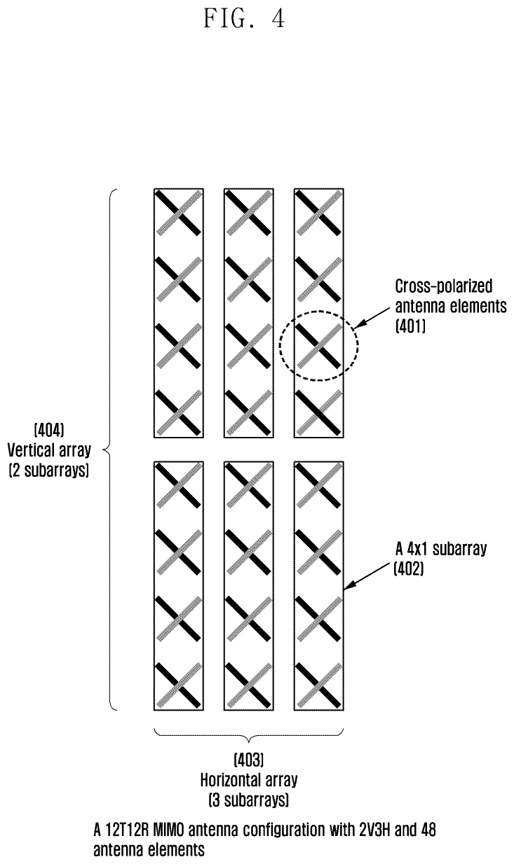

FIG. 4 illustrates an example of MIMO antenna configuration with 48 antenna elements according to an embodiment of the disclosure.

Referring to FIG. 4, 4 cross-polarized 401 antenna elements form a 4×1 subarray (402). 12 subarrays form a 2V3H MIMO antennas configuration consisting 2 and 3 subarrays (404, 403) in vertical (V) and horizontal (H) dimensions, respectively. Although FIG. 4 illustrates one example of MIMO antenna configuration, the disclosure can be applied to various such configurations.

In MIMO systems, the channel state information (CSI) is required at the base station (BS) so that a signal from the BS is received at the UE with maximum possible received power and minimum possible interference. In an embodiment, the acquisition of CSI at the BS can be via a measurement at the BS from an UL reference signal or via a measurement and feedback by the UE from a DL reference signal for time-domain duplexing (TDD, or time division duplexing) and frequency-domain duplexing (FDD, or frequency division duplexing) systems, respectively. In 5G FDD systems, the channel state information reference signal (CSI-RS) is the primary reference signal that is used by the UE to measure and report CSI.

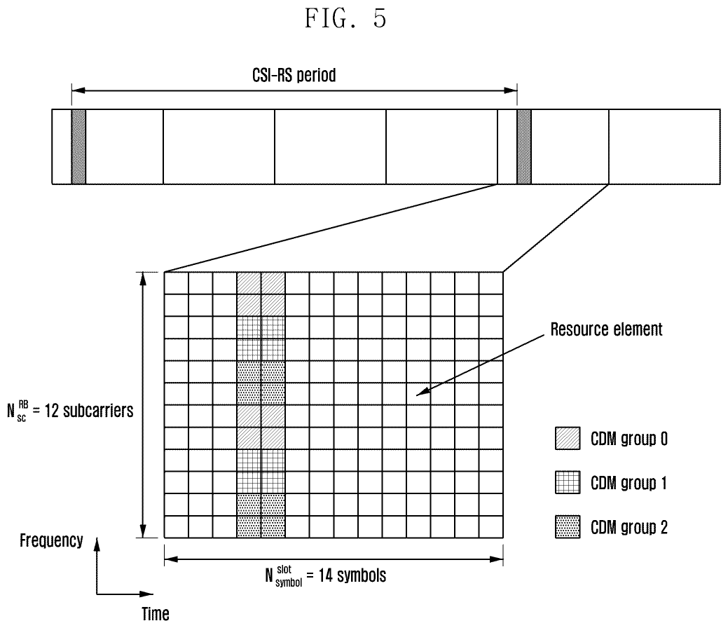

In some embodiments, a UE may receive a configuration signaling from a BS for a CSI-RS that can be used for channel measurement. An example of such configuration is illustrated in FIG. 5.

FIG. 5 illustrates layout for channel state information reference signal (CSI-RS) resource mapping in an orthogonal frequency division multiple access (OFDMA) time-frequency grid according to an embodiment of the disclosure.

Referring to FIG. 5, 12 antenna ports (CSI-RS ports) are mapped to a CSI-RS with 3 code-domain multiplexing (CDM, or code division multiplexing) groups, wherein each CDM group is mapped to 4 resource elements (REs) in OFDM time-frequency grid. The antenna ports that are mapped to the same CDM group can be orthogonalized in code-domain by employing orthogonal cover codes. The CSI-RS configuration in FIG. 5 can be related to the MIMO antenna configuration in FIG. 4, by mapping a CSI-RS port to one of the polarization of a subarray. In the 5G new radio (NR) standards, three time-domain CSI-RS resources configurations, namely: periodic, semi-persistent and aperiodic are possible. In the figure, an illustrative example of periodic configuration is given with a period of 4 slots.

In various embodiments, the BS is capable of configuring a UE, by a higher layer signaling, with information for a CSI feedback that may include spatial channel information indicator and other supplementary information that would help the BS to have an accurate CSI. The spatial channel indicator, which is reported via a precoding matrix indicator (PMI) in 4G and 5G specifications, comprises a single or a plurality of channel matrix, the channel covariance matrix, the eigenvectors, or spatial sampling basis vectors. In particular, in 4G and 5G specification, the spatial channel information can be given by a single or a plurality of discrete Fourier transform (DFT) basis vectors.

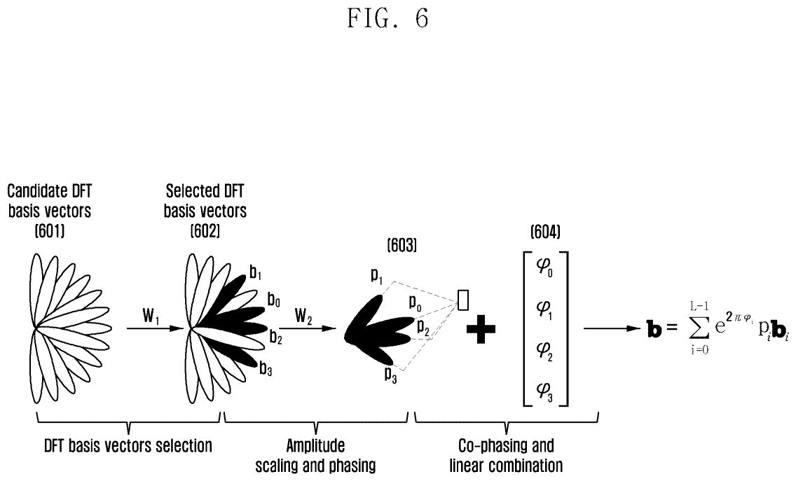

FIG. 6 illustrates an example of CSI feedback based on a plurality of DFT basis vectors for what is known as Type II CSI in 5G NR according to an embodiment of the disclosure.

The spatial information of the channel is reported in terms of L=4 DFT basis vectors {b₀, b₁, b₂, b₃3} 602 from a set of candidate DFT basis vectors 601. Additionally, amplitude information {p₀, p₁, p₂, P₃} 603 and co-phasing information {φ₀, φ₁, φ₂, φ₃} (604) are reported. Thus, in Type II CSI a dual-stage precoding matrix is given as W=W₁,W₂, where, W, select the DFT basis vectors and W, assign amplitude and co-phasing coefficients. Furthermore, a codebook can be defined as superset of candidate DFT basis vectors as well as candidate amplitude and phase coefficients. Then, a reported PMI would consist of indicators to the elements of a codebook that can represent the estimated channel.

In one embodiment, amplitude and phase information are reported in such a way that the linear combination of the basis vectors, i.e.,

$$b = {\sum }_{i = 0}^{L - 1} {e}^{2 {πφ}_{i}} {p}_{i} {b}_{i} ,$$

is matched to the eigenvector direction of the channel. Specifically, for a channel matrix H with the (s,u)-th element h_{s,u} representing the channel gain between the s-th transmit and the u-th receive antenna, the eigenvectors of the covariance matrix H^{H}H can be considered. Let eₗ denote one of the eigenvectors, then the PMI can be selected by the UE in such a way that the value

$$‖ {e}_{l}^{H} b ‖$$

is maximized.

A UE can be configured in different ways to report a tuple of DFT basis vectors, amplitude coefficients and the phase coefficients, based on polarization-common or polarization-specific manner. For example, in 5G NR specifications, DFT basis vectors are reported in a polarization-common manner while phase and amplitude coefficients are reported in polarization specific manner, i.e., reported per polarization. MIMO systems allow spatial multiplexing, i.e., transmission of data in multiple transmission layers. In this regard, the type II CSI in the 5G NR allows the DFT basis vectors to be reported in a layer-common manner, i.e., common basis for all layers, while phase and amplitude coefficients to be reported in a layer-specific manner.

In order to account for the frequency-selectivity of a wideband channel, some embodiments allow various components of the precoding matrix, i.e., components of PMI, to be reported per frequency ranges. In configurations, the frequency band the UE is configured for CSI reporting is partitioned into a set of subbands and the amplitude and/or phases coefficients are reported per a subband manner. In particular, the DL BWP can be partitioned in to subbands with subband size

$${N}_{PRB}^{SB}$$

physical resource blocks (PRBs). Then the selected DFT basis vectors are linearly combined with different weights so that the resulting vector is aligned to the eigenvector of the channel in that subband. Denoting the set of subcarriers in the k-th subband as Fₖ, then the eigenvectors of the averaged covariance matrix

$${C}_{k} = \frac{1}{\vert {F}_{k} \vert} = {\sum }_{f ∈ {F}_{k}} ( {( {H}_{f , k} )}^{H} ( {H}_{f , k} ) )$$

can be considered, where, f ∈ Fₖ are subcarriers in the k-th subband and How is the corresponding channel matrix.

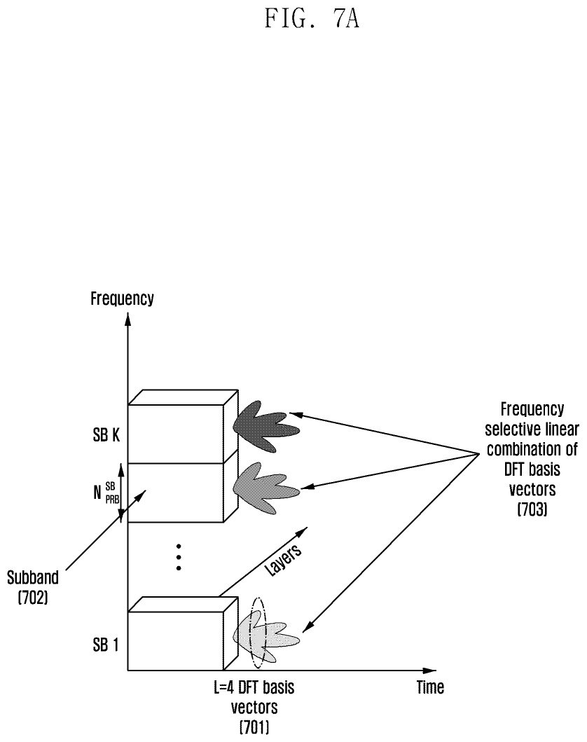

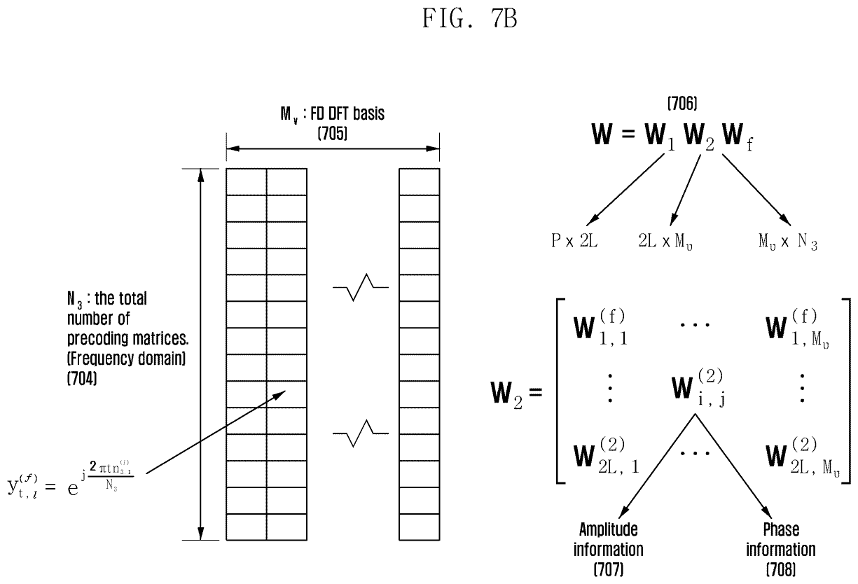

FIG. 7A illustrates an example for frequency selective linear combination of DFT basis vectors 703 for K subbands of size

$${N}_{PRB}^{SB} 702$$

according to an embodiment of the disclosure, where L=4 DFT basis vectors corresponds to SB1 (701).

In 5G NR specifications, another configuration, known as enhanced Type II (eType II) CSI, allows reporting amplitude and phase coefficients in a delay-domain rather than per subband reporting in frequency-domain. This configuration reduces the feedback overhead as the delay components are usually much smaller than the equivalent number of subbands. In enhanced Type II codebook (eType II CB) (FIG. 7B), precoding matrices are reported in delay domain by employing frequency-domain (FD) DFT basis rather than the frequency domain reporting in Type II CSI (FIG. 7A), i.e., per subband or wideband.

FIG. 7B illustrates construction of eType II CSI according to an embodiment of the disclosure.

In particular, a precoding matrix is expressed in three-stages

$$W = {W}_{1} {W}_{2} {W}_{f}^{H} ( 706 ) .$$

The spatial domain selection matrix w₁ selects L DFT vectors from P=2N₁N₂ CSI-RS ports, consequently, it has 2L rows accounting for the cross-polarized antennas. Moreover, an M×N₃ matrix

$${W}_{f}^{H}$$

corresponds to Mᵥ DFT basis vectors (705) that can transform the precoding matrix reported in delay domain for Mᵥ delay components to a frequency domain with N₃ frequency domain points (bins), where N₃ corresponds to the total number of precoding matrices in frequency domain (704). In particular, the t ⊂ {1,2 . . . , N₃}-th element of f-th vector is given by

$${y}_{t , l}^{( f )} = {e}^{j \frac{2 π t {n}_{3 , l}^{( f )}}{{N}_{3}}} .$$

Finally, the matrix w₂ carries the amplitude and phase information wherein the i-th and j-th element, w_{i,j}, carries amplitude (707) and phase (708) information of i-th 2D DFT beam and j-th delay component.

In order to further reduce the CSI overhead, a system may exploit angle-delay reciprocity and measure the dominant angle and delay components of a channel from an UL reference signal such as sounding reference signal (SRS). Then, a precoded CSI-RS can be considered for DL CSI measurement wherein the CSI-RS ports are mapped to an angle-delay component of the channel. Delay pre-compensation can be applied to the CSI ports so that the UE would measure CSI for a fewer number of delay components, i.e., in the extreme case for just one delay component.

Recently, artificial intelligence (AI)-based CSI feedback has gained considerable attention.

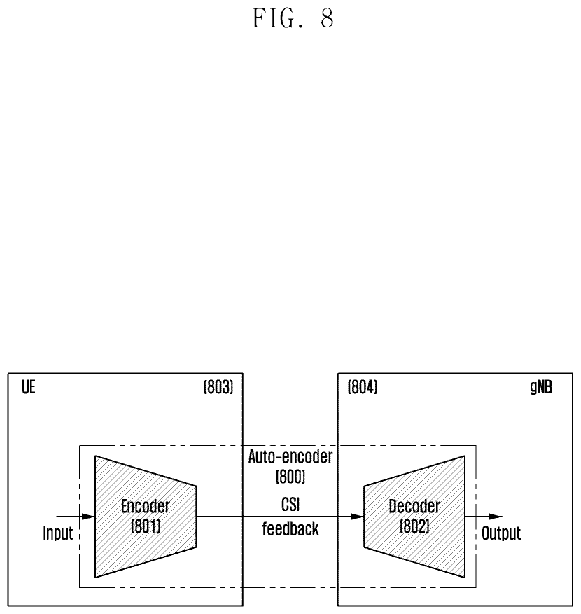

FIG. 8 illustrates an autoencoder (800) based CSI feedback according to an embodiment of the disclosure.

In particular, an auto-encoder (AE), as depicted in FIG. 8, consisting of an encoder part (801) at the UE (803) generates the CSI feedback and a decoder (802) at the gNB (804) reconstructs the CSI feedback. The main aim of an AE-based CSI feedback (or AI-based CSI feedback) is to find the best representation of a channel state information in terms of feedback overhead. In another words, AE compresses the CSI to reduce the CSI feedback overhead.

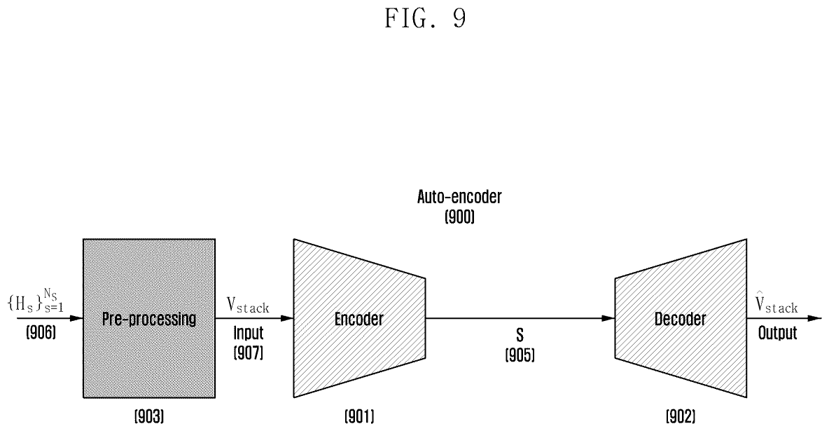

The input for an autoencoder can take different formats. In one embodiment, the input can be the eigenvectors of the channel. The covariance matrix of an Nₜ×Nᵣ channel matrix H given as H^{H}H can be computed by the UE. Then, the dominant eigenvectors of the covariance matrix svd (H^{H}H)=VΣ∧ given as V=[v₁ . . . vᵣ] can be considered as an input for the autoencoder. An illustration of such embodiment is given in FIG. 9.

FIG. 9 depicts an embodiment for an autoencoder (900) based CSI feedback wherein a preprocessing unit transforms the estimated channel to stacked eigenvectors according to an embodiment of the disclosure.

A set of Nₛ channel matrices which belong to Nₛ subbands, i.e.,

$${\{ {H}_{s} \}}_{s = 1}^{{N}_{s}} ,$$

is input (906) for a pre-processing unit in (903). The preprocessing unit compute the Ns eigenvectors and stack them as a column of a matrix V_{stack} (907). An encoder (901) is then generates a CSI feedback in terms of a bit stream s (905). The decoder (902) part of the autoencoder, takes the CSI feedback and reconstructs the stacked eigenvectors. Moreover, a gNB then may use the reconstructed stacked eigenvectors \hat{V}stack as precoders.

### REFERENCES

[1] RP-193133, New WID: Further enhancements on MIMO for NR, Samsung

[2] 3GPP TS 38.213, V15.12.0 (2020-12): “NR; Physical layer procedures for control (Release 15)”,

[3] 3GPP TS 38.214, V15.11.0 (2020-09): “NR; Physical layer procedures for data (Release 15)”,

[4] 3GPP TS 38.213, V16.4.0 (2020-12): “NR; Physical layer procedures for control (Release 16)”

[5] 3GPP TS 38.214, V16.4.0 (2020-12): “NR; Physical layer procedures for data (Release 16)”,

3GPP TS 38.321, V16.3.0 (2020-12): “NR; Medium Access Control (MAC) protocol specification (Release 16)”,

3GPP TS 38.331, V16.3.1 (2021-01): “NR; Radio Resource Control (RRC) protocol specification

[8] 3GPP TS 38.211, V16.4.0 (2020-12): “NR; Physical channels and modulation.”

[9] 3GPP TS 38.212, V16.4.0 (2020-12): “NR; Multiplexing and channel coding.”

3GPP TS 38.215, V16.4.0 (2020-12): “NR; Physical layer measurements”

The below flowcharts illustrate example methods that can be implemented in accordance with the principles of the disclosure and various changes could be made to the methods illustrated in the flowcharts herein. For example, while shown as a series of steps, various steps in each figure could overlap, occur in parallel, occur in a different order, or occur multiple times. In another example, steps may be omitted or replaced by other steps.

As illustrated in the previous sections, the CSI generation, particularly, the precoding matrix indication (PMI) can be based on a predefined fixed codebook or directly generated by an AI/ML model. In some cases, it is required to check the performance of the AI/ML model-based CSI generation. This may require defining the baseline performance, e.g., the one that could be obtained by predefined codebook. In practical cases, the UE may have to support both AI/ML-based CSI generation as well as codebook-based CSI representation. In some consideration, the UE may be indicated by the gNB to fallback to codebook based CSI generation when the performance of AI/ML-based approach is below the baseline. However, the performance monitoring and the consequent fallback operations incur processing and signaling overheads, thus, required to be avoided as much as possible.

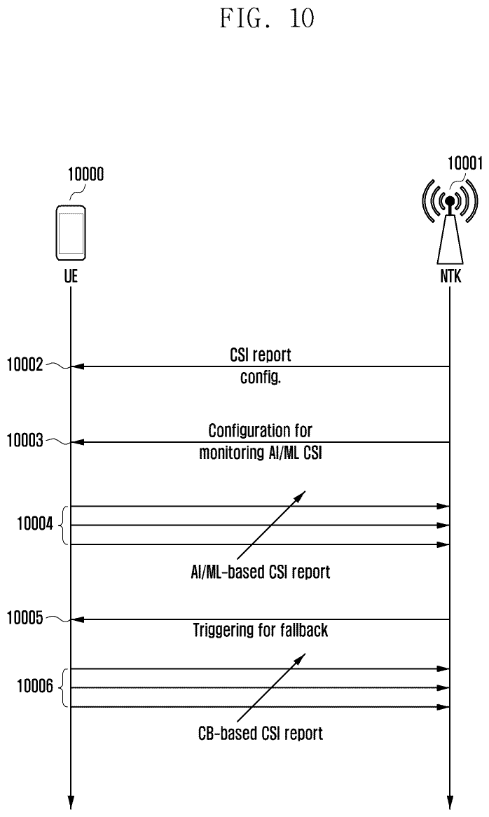

FIG. 10 illustrates signaling exchange between the UE (10000) and gNB network (NTK) (10001) for aforementioned AI/ML-based CSI report and its monitoring according to an embodiment of the disclosure.

The UE may first be configured with CSI report configuration (10002) and the corresponding monitoring related configurations (10003). The monitoring related configuration (10003) may constitute baseline method, e.g., codebook for baseline CSI generation, the monitoring metric key performance indicator (KPI) and performance monitoring reporting criteria, e.g., threshold on the KPI. The UE may report AI/ML-based CSI (10004) according to the configuration. The UE may additionally report additional information, e.g., computed KPI, for performance monitoring of AI/ML-based CSI. Based on UE's report for performance monitoring, the gNB may trigger fallback CSI based reporting (10005). According to the triggering message, the UE then reports the CSI based on CB-based CSI report (10006).

### PMI Reporting

In order to reduce the performance fluctuation of AI/ML-based CSI generation and the associated signaling overhead for fallback, the CSI generation can be partly be based on codebook.

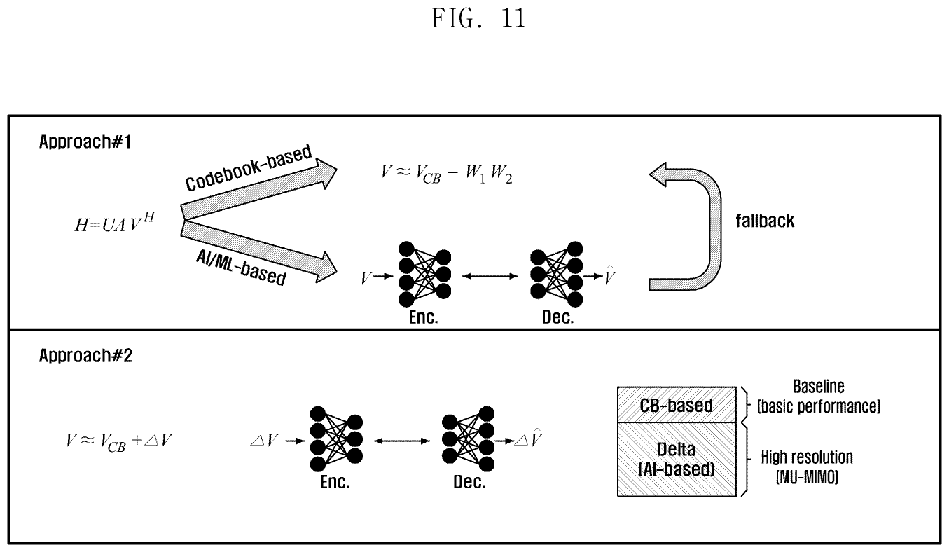

FIG. 11 illustrates two approaches for the co-configuration of AI/ML-based CSI feedback and codebook-based CSI feedback according to an embodiment of the disclosure.

For example, as illustrated in Approach #2 of FIG. 11, the UE may generate CSI, particularly the precoding information, in two components. The first component may constitute codebook based CSI (V_{CB}) while the second component is generated by an AI/ML model. In an embodiment, the AI/ML generated CSI can take the delta CSI (ΔV), i.e., the difference between the ground truth or what UE intended to report (V) and the precoding vector reported by the first component (V_{CB}). This approach effectively minimize the dynamic range and sensitivity of the CSI reconstruction to error.

In the following, various methods to alleviate/resolve the aforementioned limitations are presented.

In one aspect of this disclosure, in Method I, as illustrated in FIG. 11, the network configures the UE with a CSI report configuration. The CSI reporting configuration includes configuration information for precoding matrix indication (PMI) wherein the PMI is configured to be reported in two components. Particularly, the network configures the UE with codebook configuration (codebook-based CSI reporting configuration) for the first component as well as AI/ML-based CSI reporting configuration for the second component. The UE, upon receiving such configuration, determines the two components of PMI to represent the preferred precoding vector (V), by first determining the PMI for the first component corresponding to the precoding vector (V_{CB}) and then determining a second component corresponding to a differential (delta) precoding vector (ΔV). The UE reports the two PMI components in such a way that the preferred precoding vector is approximated as V≈V_{CB}+ΔV.

### Spatial (Ports) Domain Aspects

In one aspect of this disclosure, in Method I.1, the network configures the UE with a CSI report configuration. The CSI reporting configuration includes, for example, configuration information for precoding matrix indication (PMI) wherein the PMI is configured to be reported in two components. Particularly, the network configures the UE with codebook configuration for the first component as well as AI/ML-based CSI reporting configuration for the second component. Particularly, the network provides two configuration parameters for the number of ports corresponding to the first and the second PMI components.

The network configures the UE with a parameter to configure the number of ports to calculate PMI for the first PMI component denoted by P_{CB}.

The network configures the UE with a parameter to configure the number of ports to calculate PMI for the second PMI component denoted by P_{CSI}.

As one embodiment of Method I.1., the network may configure the UE with P_{CB} in relation to P_{CSI} by configuring parameter for number of ports for the second component and the number of port scaling factor, e.g.,

$$γ = \frac{{P}_{CSI}}{{P}_{CB}} .$$

In accordance to Method I.1., the CSI reporting configuration may constitute of configuration for CSI measurement. The UE expects to be configured with CSI-RS resources with the same number of ports as the configured P_{CSI}.

If P_{CSI} is not explicitly configured, the UE assumes P_{CSI} is the same as the number of ports for the configured CSI-RS resources.

In practical cases 2D planar antenna arrays are assumed. In this case, the arrangement of antenna ports in the two dimensions need to be configured.

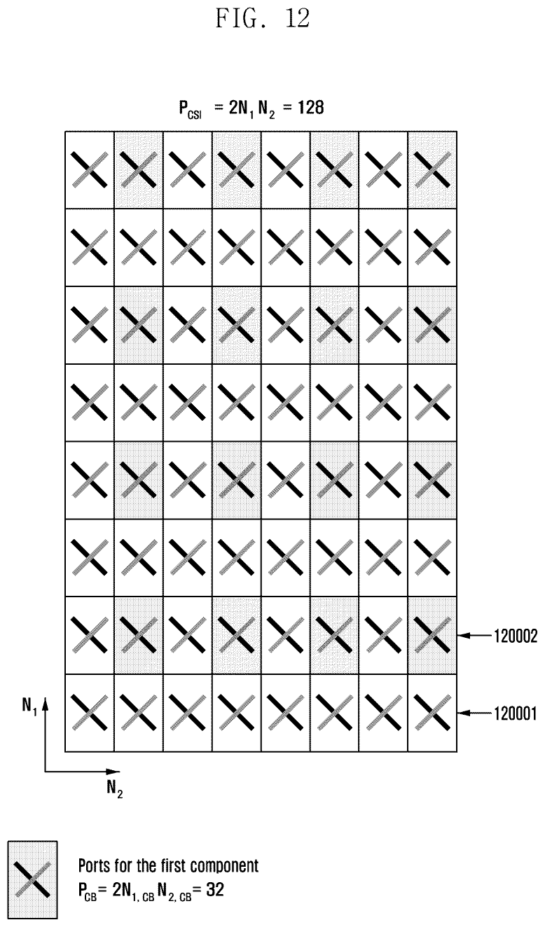

In one aspect of Method I.1., when a 2D planar antenna array is assumed, the CSI reporting configuration with two parameters for the number of ports where the first parameter for the first PMI component and the second parameter for the second PMI component, where each parameter includes information on the number of ports in the first and second dimension. An embodiment is provided in FIG. 12.

FIG. 12 illustrates antenna ports configuration for AI/ML-based CSI feedback and codebook-based CSI feedback according to an embodiment of the disclosure.

Referring to FIG. 12, the number of ports for the second component is illustrated as P_{CSI}=2N₁N₂=2×8×8=128 whereas the number of ports in the first and second dimension are eight, i.e., N₁=8, N₂=8 (120001). Conversely, the number of ports for the second PMI component is illustrated as P_{CB}=2N_{CB,1}N_{CB,2}=2×4×4=64 whereas the number of ports in the first and second dimension are four, i.e., N₁=4, N₂=4 (120002).

In one aspect of Method I.1., when a 2D planar antenna array is assumed, the CSI reporting configuration with two parameters for the number of ports where the first parameter indicates P_{CB} ports for the first PMI component and the second parameter indicates P_{CSI} ports for the second PMI component,

the network configures the UE with a bitmap based ports indicator with for the first component wherein the bitmap has a length of P_{CSI} to map P_{CB} ports out of P_{CSI} ports where a bit value of ‘1’ indicates the corresponding port considered for the first CSI component

the ports are ordered in the consecutive manner from most significant bit (MSB) to least significant bit (LSB) wherein the first bit with value ‘1’ in the bitmap corresponds to the first port

the UE determines P_{CB} as the number of bits in the bitmap with bit value of ‘1’.

### Reporting Frequency Units (Subbands) Aspects

In a yet another aspect of this disclosure, in Method I.2, the network configures the UE with a CSI report configuration. The CSI reporting configuration includes configuration information for precoding matrix indication (PMI) wherein the PMI is configured to be reported in two components. The network configures the UE with codebook configuration for the first component as well as AI/ML-based CSI reporting configuration for the second component. Particularly, the network provides two configuration parameters for the number of subbands corresponding to the first and the second PMI components.

The network configures the UE with a parameter to configure the number of subbands to calculate PMI for the first component denoted by N_{SB,CB}.

The network configures the UE with a parameter to configure the number of subbands to calculate PMI for the second component denoted by N_{SB}.

As one embodiment of Method I.2., the network may configure the UE N_{SB,CB} in relation to N_{SB} by configuring parameter for number of subbands for the second component as well as the number of subbands scaling factor denoted by

$${γ}_{SB} = \frac{{N}_{SB}}{{N}_{SB , CB}} .$$

In one aspect of Method I.2., in Method I.2.1., the CSI reporting configuration with two parameters for the number of ports where the first parameter indicates N_{SB,CB} subbands for the first PMI component and the second parameter indicates N_{SB} subbands for the second PMI component,

the network configures the UE with a bitmap based indicator for the first component wherein the bitmap has a length of N_{SB} to map N_{SB,CB} subbands out of N_{SB} subbands, where a bit value of ‘1’ indicates the corresponding port considered for the first CSI component.

the ports are ordered in the consecutive manner from MSB to LSB wherein the first bit with value ‘1’ in the bitmap corresponds to the first subband from lowest to highest frequency.

the UE determines N_{SB,CB} as the number of bits in the bitmap with bit value of ‘1’.

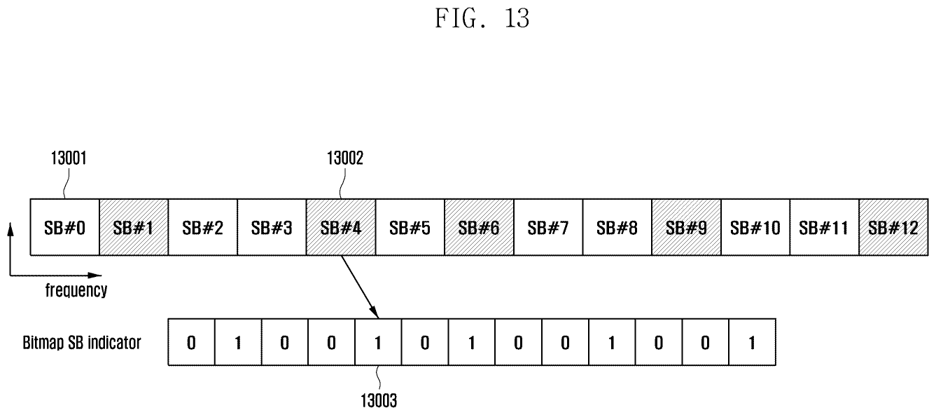

FIG. 13 illustrates a bitmap based indicator for the first PMI component according to an embodiment of the disclosure.

Referring to FIG. 13, N_{SB,CB}=5 subbands are considered for the first PMI component out of the N_{SB}=13 PMI components. As illustrated, the second bit with the value of ‘1’ (13003) corresponds to the second subband selected for the first PMI component, i.e., SB#4, (13002). In an embodiment, the first bit of the bitmap SB indicator corresponds to the first SB (SB#0) (13001), the second bit of the bitmap SB indicator corresponds to the second SB (SB#1), and so on. The fifth bit (13003) of the bitmap SB indicator corresponds to the fifth SB (SB#4) (13002) and the fifth bit (13003) with the value ‘1’ corresponds to the SB#4 (13002) selected for the first PMI component.

As one embodiment of Method I.2., in Method I.2.2., when the network configures the UE N_{SB,CB} in relation to N_{SB} by configuring parameter for number of subbands for the second component as well as a scaling factor for the number of subbands denoted by γ_{SB}

the UE considers the set of subbands

$${N}_{SB , CB} = ⌈ \frac{{N}_{SB}}{{γ}_{SB}} ⌉$$

for the first PMI component where the first subband for the first PMI component corresponds to the first γ_{SB} subbands of the second PMI component, the n-th subband of the first PMI component corresponds to the (n−1)×γ_{SB}+1, . . . , n×γ_{SB} subbands of the second PMI component.

The UE assumes the subband size of the first PMI component, except for the last subband from the lowest to the highest frequency, as γ_{SB} times the subband size of the second PMI component. The last subband of the first PMI component would have the size of

$${N}_{SB , CB} = {N}_{SB} - {γ}_{SB} ⌊ \frac{{N}_{SB}}{{γ}_{SB}} ⌋ .$$

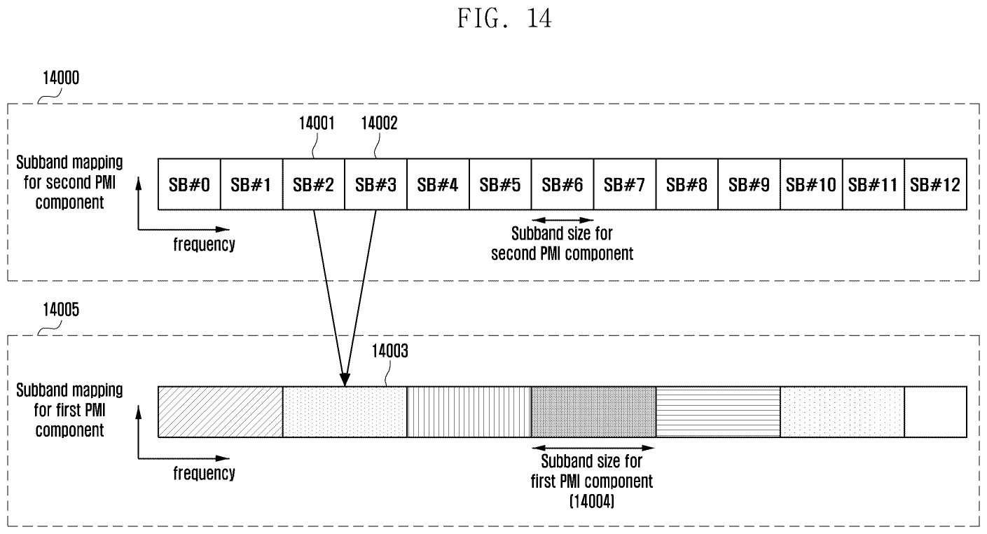

FIG. 14 illustrates implementation of Method I.2.2 according to an embodiment of the disclosure.

Referring to FIG. 14, γ_{SB}=2 subbands of the second PMI component (14000) are considered for each of subbands of the first PMI component (14005). As a result the N_{SB}=13 subbands from the second PMI component are grouped to form N_{SB,CB}=7 subbands for the first PMI component. As example, the second subband for the first PMI component (14003) corresponds to the SB#2 (14001) and SB#4 (14002) of the second PMI component.

### Quantization Aspects

In some cases, it is essential to configure different quantization levels for the two PMI components. Depending on the design, the allowed UE processing complexity and some other aspects, the configuration aspects may share common configuration parameters. In the following, methods for the gNB to configure with a common and separate sets of parameters for the determination of first and second PMI components is provided.

In one aspect of this disclosure, in Method I.3.1, the network configures the UE with a CSI report configuration. The CSI reporting configuration includes configuration information for precoding matrix indication (PMI) wherein the PMI is configured to be reported in two components. The network configures the UE with codebook configuration for the first component as well as AI/ML-based CSI reporting configuration for the second component. Particularly, the network configures the UE to report PMI for a precoding vectors in the form V=W₁W₂(W_{f}⊗W_{d})^{H} with indicators for spatial-domain (SD) basis (W₁), frequency domain (FD) basis (W_{f}), Doppler domain (DD) basis (W_{d}) and combining coefficients (W₂).

The UE reports the combining coefficients W₂=W_{2,CB}+ΔW₂ with two components, where the indicators for the first PMI component W_{2,CB} are determined from a predefined codebook while indication for the second PMI component ΔW₂ is generated by an AI/ML model.

The UE reports a single set of indicators for SD, FD, DD basis vectors applicable for both the first and second PMI components from a single set of configured parameter, e.g., parameters to determine number of SD, FD and DD basis vectors.

In some case, e.g., higher UE processing power is available, deployment scenario, etc, it may be possible to configure the UE with two separate sets of parameters for the derivation of the first and second PMI components. Particularly, to achieve higher-resolution precoding information via the second set of parameters, the network may configure a separate set of parameters

In one aspect of this disclosure, in Method I.3.2, the network configures the UE with a CSI report configuration. The CSI reporting configuration includes, for example, configuration information for precoding matrix indication (PMI) wherein the PMI is configured to be reported in two components. Particularly, the network configures the UE with codebook configuration for the first component as well as AI/ML-based CSI reporting configuration for the second component. Particularly, the network configures the UE to report PMI for a precoding vectors in the form V=W_{1,CB}W_{2,CB}(W_{f,CB}⊗W_{d,CB})^{H}+W_{1,2}ΔW₂(W_{f,2}⊗W_{d,2})^{H} with separate spatial-domain (SD) indicators for basis (W₁ and W_{1,CB}), frequency domain (FD) basis (W_{f}), Doppler domain (DD) basis (W_{d}) and combining coefficients (W₂).

The UE reports the combining coefficients W_{2,CB} and ΔW₂ with two components, where the indicators for the first PMI component W_{2,CB} are determined from a predefined codebook while indication for the second PMI component ΔW₂ is generated by an AI/ML model.

The UE reports a two sets of indicators for SD, FD, DD basis vectors, where the first set corresponds to the first PMI component, i.e., indicators for W_{1,CB}, W_{f,CB} and W_{d,CB}, and a second set of indicators corresponds to the second PMI components, i.e., indicators for W_{1,2}, W_{f,2} and W_{d,2}.

The network configures the UE with separate set of parameters, e.g., parameters to determine number of SD, FD and DD basis vectors for the first and second PMI components.

### CQI Reporting

The channel quality indication (CQI) is an essential part of CSI report that enables the network to efficiently assess the channel quality and adapt its transmission rate. The CQI is computed at the UE on the basis of the reported PMI, i.e., assuming the bases station would apply the precoder corresponding to the reported PMI. In accordance of one aspect of this disclosure, when the UE is configured to report PMI in two components, it is essential to define how the UE determine the CQI.

In one embodiment of this disclosure, in Method II.1, the network configures the UE with a CSI report configuration. The CSI reporting configuration includes configuration information for precoding matrix indication (PMI) wherein the PMI is configured to be reported in two components. Particularly, the network configures the UE with codebook configuration for the first component as well as AI/ML-based CSI reporting configuration for the second component. Moreover, the CSI report configuration includes configuration information for channel quality indication (CQI), where the UE determines the CQI based on the basis of the aggregated precoding vector (V) indicated by the first and second PMI components, i.e., V=V_{CB}+ΔV where V_{CB} and ΔV correspond to precoding vectors indicated by the first and second PMI component.

if the time and/or frequency granularities for CQI reporting is not explicitly configured, the UE applies the time/frequency granularity configured for the second PMI component.

if the time and/or frequency granularities for CQI reporting is configured in relation to the time and/or frequency granularities for PMI reporting, the UE applies the time/frequency granularity by apply the configured scaling factor on the basis of the configured time/frequency granularities for the second PMI component.

In some cases, it is beneficial for the network to have the CQI corresponding to the first PMI component separately. This may allow the network to configure just the first PMI component, hence lower uplink overhead, if high resolution precoding information conveyed by the two PMI components does not bring about enough benefits as compared to the lower resolution precoding information corresponding to the first PMI.

In one embodiment, in Method II.2, the network configures the UE with a CSI report configuration. The CSI reporting configuration includes configuration information for precoding matrix indication (PMI) wherein the PMI is configured to be reported in two components. Particularly, the network configures the UE with codebook configuration for the first component as well as AI/ML-based CSI reporting configuration for the second component. Moreover, the CSI report configuration includes configuration information for channel quality indication (CQI), where

the UE reports two CQI components

the UE determines the first CQI based on the precoder corresponding to the first PMI component V_{CB}, denoted by CQI_{CB}=f(V_{CB})

the UE determines the second CQI component as a differential CQI defined as the difference between the CQI calculated based on the aggregated precoding vector V=V_{CB}+ΔV and the first CQI, i.e., ΔCQI=f(V_{CB}+ΔV)−CQI_{CB}

if the time and/or frequency granularities for CQI reporting is not explicitly configured, the UE applies the time/frequency granularity configured for the first PMI component as the time/frequency granularity for the first CQI component and the time/frequency granularity configured for the second PMI component as the time/frequency granularity for the second CQI component.

if the time and/or frequency granularities for CQI reporting is configured in relation to the time and/or frequency granularities for PMI reporting, the UE applies the time/frequency granularity for the first CQI by apply the configured scaling factor on the basis of the configured time/frequency granularities for the first PMI component and the UE applies the time/frequency granularity for the second CQI component by apply the configured scaling factor on the basis of the configured time/frequency granularities for the second PMI component

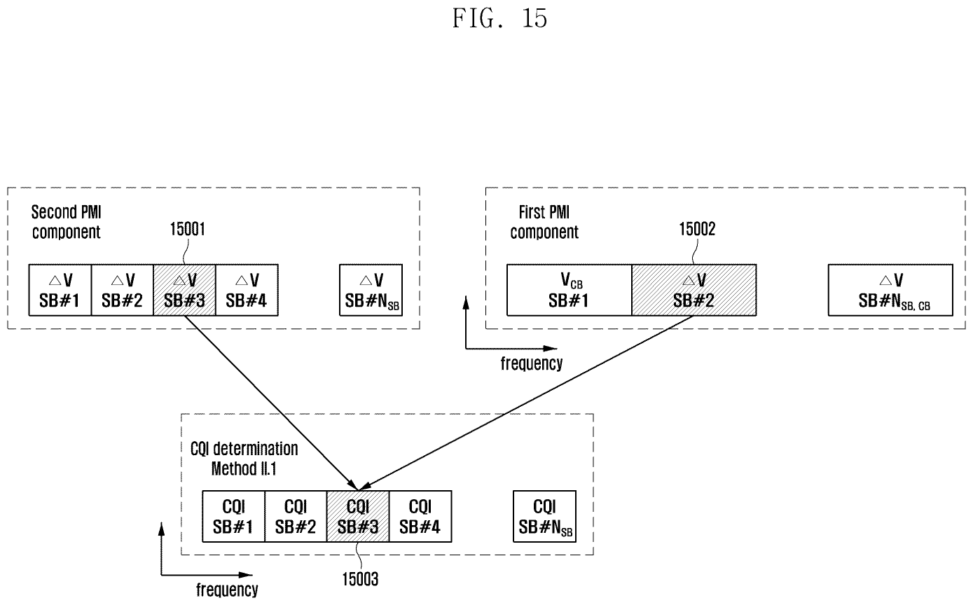

FIG. 15 illustrates CQI determination in accordance to Method II.1 according to an embodiment of the disclosure.

Referring to FIG. 15, a single CQI component is determined from the aggregated precoder from the first and second PMI components. Referring to FIG. 15, the time/frequency granularity for the determined CQI follows the second PMI component (150001). As an example, the CQI for the SB #3 for CQI (15003) is computed based SB #3 and SB #2 of the second (15001) and first (15002) PMI components, respectively.

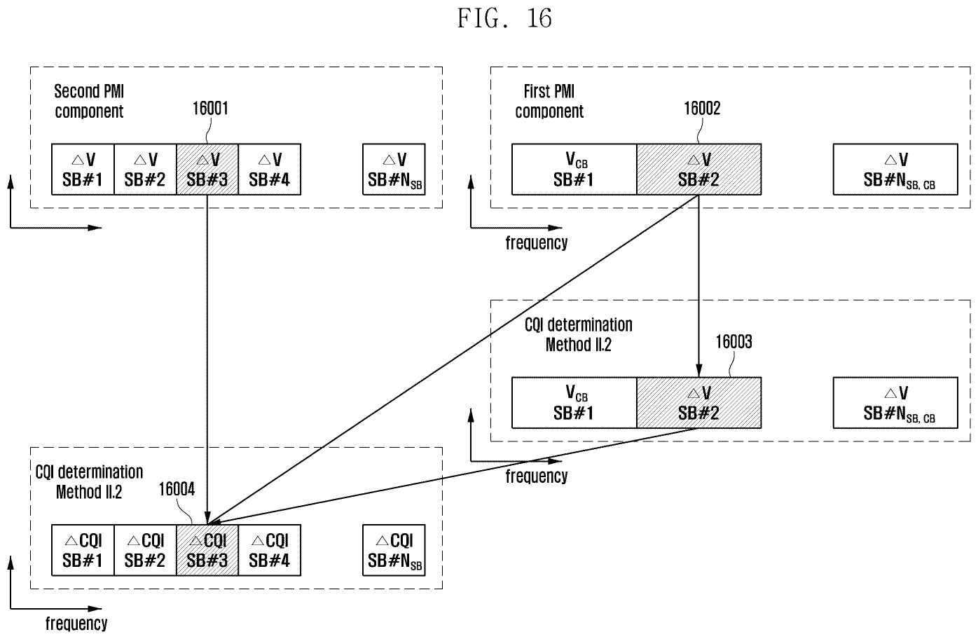

FIG. 16 illustrates CQI determination in accordance to Method II.2 according to an embodiment of the disclosure.

Referring to FIG. 16, a two CQI components are determined, where the first CQI component is determined from PMI component and the second CQI component is determined from the aggregated precoder from the first and second PMI components. As illustrated in the figure the time/frequency granularity for the determined first CQI follows the first PMI component and the frequency granularity of the second CQI component follows the frequency granularity of the second PMI component. As an example, the CQI for the SB#3 for second CQI (16004) is computed based SB#3 and SB#2 of the second (16001) and first (16002, 16003) PMI components, respectively.

### Time Domain Properties

In various cases, the lower resolution CSI component has a slower changing rate in the time domain as compared to the higher resolution component. In this case, it is beneficial to configure the UE to report the first component of PMI at a slower rate as compared to the higher resolution second component.

In one embodiment of the disclosure, in Method III.1, the network configures the UE with a CSI report configuration. The CSI reporting configuration includes configuration information for precoding matrix indication (PMI) wherein the PMI is configured to be reported in two components. Particularly, the network configures the UE with codebook configuration for the first component as well as AI/ML-based CSI reporting configuration for the second component. Moreover, when the CSI report configuration includes configuration information for periodic or semi-persistent reporting, the network may configure the UE to report the first PMI component once for every N consecutive reports of the second PMI component

the UE determines the second CQI based on the first PMI and second PMI by considering the latest determined first PMI component and the second PMI component to be reported in the CSI report that carries the second CQI component.

if the CSI report does not contain the first PMI component the UE shall not report the first CQI component.

In one aspect of this disclosure, in Method III.2, the network configures the UE with a CSI report configuration. The CSI reporting configuration includes configuration information for precoding matrix indication (PMI) wherein the PMI is configured to be reported in two components. The network configures the UE with codebook configuration for the first component as well as AI/ML-based CSI reporting configuration for the second component. Moreover, when the CSI report configuration includes configuration information for aperiodic reporting, the network may configure the UE to report a single report for the first PMI component and N consecutive reports of the second PMI component

the UE determines the second CQI based on the first PMI and second PMI by considering the latest determined first PMI component and the second PMI component to be reported in the CSI report that carries the second CQI component.

if the CSI report does not contain the first PMI component the UE shall not report the first CQI component.

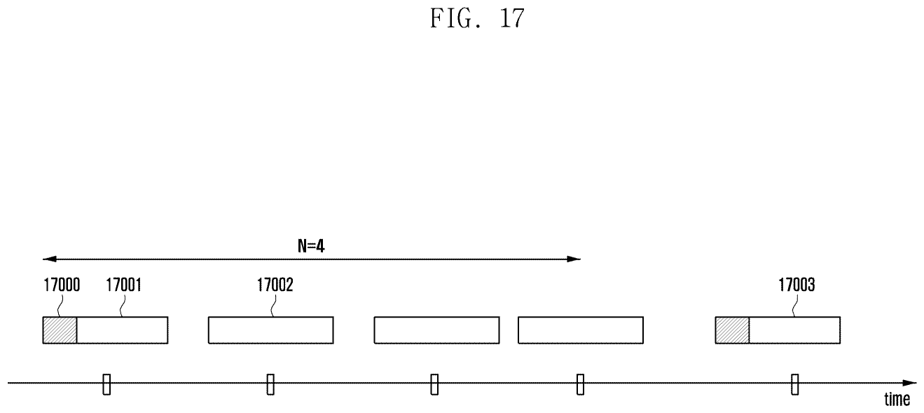

FIG. 17 illustrates periodic/semi-persistent reporting for CSI configuration with two PMI components according to an embodiment of the disclosure.

Referring to FIG. 17, the UE reports the first component (17000) and (17003) once in every N=4 consecutive reports while the UE reports the second PMI component (17001) in every report (e.g., 17002).

It will be appreciated that various embodiments of the disclosure according to the claims and description in the specification can be realized in the form of hardware, software or a combination of hardware and software.

Any such software may be stored in non-transitory computer readable storage media. The non-transitory computer readable storage media store one or more computer programs (software modules), the one or more computer programs include computer-executable instructions that, when executed by one or more processors of an electronic device individually or collectively, cause the electronic device to perform a method of the disclosure.

Any such software may be stored in the form of volatile or non-volatile storage such as, for example, a storage device like read only memory (ROM), whether erasable or rewritable or not, or in the form of memory such as, for example, random access memory (RAM), memory chips, device or integrated circuits or on an optically or magnetically readable medium such as, for example, a compact disk (CD), digital versatile disc (DVD), magnetic disk or magnetic tape or the like. It will be appreciated that the storage devices and storage media are various embodiments of non-transitory machine-readable storage that are suitable for storing a computer program or computer programs comprising instructions that, when executed, implement various embodiments of the disclosure. Accordingly, various embodiments provide a program comprising code for implementing apparatus or a method as claimed in any one of the claims of this specification and a non-transitory machine-readable storage storing such a program.f

While the disclosure has been shown and described with reference to various embodiments thereof, it will be understood by those skilled in the art that various changes in form and details may be made therein without departing from the spirit and scope of the disclosure as defined by the appended claims and their equivalents.

What is claimed is:

1. A method performed by a user equipment (UE) in a communication system, the method comprising:
receiving first configuration information associated with codebook-based precoding matrix indicator (PMI) determination and second configuration information associated with artificial intelligence/machine learning (AI/ML)-based PMI determination;
determining a first PMI component based on the first configuration information;
transmitting the first PMI component;
determining a second PMI component based on the second configuration information and an AI/ML model configured for the AI/ML-based PMI determination; and
transmitting the second PMI component,
wherein the second PMI component corresponds to a differential precoding matrix with respect to a precoding matrix corresponding to the first PMI component.

2. The method of claim 1,
wherein the first PMI component is determined based on a number of ports for the first PMI component and the second PMI component is determined based on a number of ports for the second PMI component, and
wherein:
the number of ports for the first PMI component is identified based on the first configuration information, and the number of ports for the second PMI component is identified based on the number of ports for the first PMI component and a port scaling factor to scale the number of ports for the first PMI component, wherein the port scaling factor is configured based on the second configuration information, or
(i) in case that the number of ports for the second PMI component is explicitly configured based on the second configuration information, the number of ports for the second PMI component is the configured number, and in case that the number of ports for the second PMI component is not explicitly configured, the number of ports for the second PMI component is identical to a number of ports for channel state information (CSI) reference signal, and (ii) the number of ports for the first PMI component is identified based on a bitmap based port indicator to indicate ports for the first PMI component among the number of ports for the second PMI component, wherein the bitmap based port indicator is configured based on the first configuration information.

3. The method of claim 1,
wherein the first PMI component is determined based on a first number of subbands and the second PMI component is determined based on a second number of subbands,
wherein:
the number of subbands for the first PMI component is identified based on the first configuration information, and the number of subbands for the second PMI component is identified based on the number of subbands for the first PMI component and a subband scaling factor to scale the number of subbands for the first PMI component, wherein the subband scaling factor is configured based on the second configuration information, or
the number of subbands for the second PMI component is identified based on the second configuration information, and the number of subbands for the first PMI component is identified based on a bitmap based subband indicator to indicate subbands for the first PMI component among the subbands for the CSI reference signal, wherein the bitmap based subband indicator is configured based on the first configuration information.

4. The method of claim 1,
wherein information on first combining coefficients corresponding to the first PMI component is transmitted with the first PMI component and information on second combining coefficients corresponding to the second PMI component is transmitted with the second PMI component,
wherein the first combining coefficients are determined based on the first configuration information and the second combining coefficients are determined based on the second configuration information and the AI/ML model, and
wherein the second combining coefficients correspond to delta values with respect to the first combining coefficients.

5. The method of claim 1,
wherein in case that the UE is not configured to report channel quality indicator (CQI) in one component, the CQI is determined based on an aggregation of the precoding matrix corresponding to the first PMI component and the differential precoding matrix corresponding to the second PMI component, and
wherein in case that the UE is configured to report the CQI in two components, a first CQI component is determined based on the precoding matrix corresponding to first PMI component and a second CQI component corresponds to a differential CQI between the CQI determined based on the aggregation of the precoding matrix corresponding to the first PMI component and the differential precoding matrix corresponding to the second PMI component and the first CQI component.

6. The method of claim 1, wherein the first PMI component is transmitted once for N transmissions of the second PMI component.

7. A user equipment (UE) in a communication system, the UE comprising:
a transceiver; and
a processor coupled with the transceiver and configured to:
receive first configuration information associated with codebook-based precoding matrix indicator (PMI) determination and second configuration information associated with artificial intelligence/machine learning (AI/ML)-based PMI determination,
determine a first PMI component based on the first configuration information,
transmit the first PMI component,
determine a second PMI component based on the second configuration information and an AI/ML model configured for the AI/ML-based PMI determination, and
transmit the second PMI component,
wherein the second PMI component corresponds to a differential precoding matrix with respect to a precoding matrix corresponding to the first PMI component.

8. The UE of claim 7,
wherein the first PMI component is determined based on a number of ports for the first PMI component and the second PMI component is determined based on a number of ports for the second PMI component, and
wherein:
the number of ports for the first PMI component is identified based on the first configuration information, and the number of ports for the second PMI component is identified based on the number of ports for the first PMI component and a port scaling factor to scale the number of ports for the first PMI component, wherein the port scaling factor is configured based on the second configuration information, or
(i) in case that the number of ports for the second PMI component is explicitly configured based on the second configuration information, the number of ports for the second PMI component is the configured number, and in case that the number of ports for the second PMI component is not explicitly configured, the number of ports for the second PMI component is identical to a number of ports for channel state information (CSI) reference signal, and (ii) the number of ports for the first PMI component is identified based on a bitmap based port indicator to indicate ports for the first PMI component among the number of ports for the second PMI component, wherein the bitmap based port indicator is configured based on the first configuration information.

9. The UE of claim 7,
wherein the first PMI component is determined based on a first number of subbands and the second PMI component is determined based on a second number of subbands,
wherein:
the number of subbands for the first PMI component is identified based on the first configuration information, and the number of subbands for the second PMI component is identified based on the number of subbands for the first PMI component and a subband scaling factor to scale the number of subbands for the first PMI component, wherein the subband scaling factor is configured based on the second configuration information, or
the number of subbands for the second PMI component is identified based on the second configuration information, and the number of subbands for the first PMI component is identified based on a bitmap based subband indicator to indicate subbands for the first PMI component among the subbands for the CSI reference signal, wherein the bitmap based subband indicator is configured based on the first configuration information.

10. The UE of claim 7,
wherein information on first combining coefficients corresponding to the first PMI component is transmitted with the first PMI component and information on second combining coefficients corresponding to the second PMI component is transmitted with the second PMI component,
wherein the first combining coefficients are determined based on the first configuration information and the second combining coefficients are determined based on the second configuration information and the AI/ML model, and
wherein the second combining coefficients correspond to delta values with respect to the first combining coefficients.

11. The UE of claim 7,
wherein in case that the UE is not configured to report channel quality indicator (CQI) in one component, the CQI is determined based on an aggregation of the precoding matrix corresponding to the first PMI component and the differential precoding matrix corresponding to the second PMI component, and
wherein in case that the UE is configured to report the CQI in two components, a first CQI component is determined based on the precoding matrix corresponding to first PMI component and a second CQI component corresponds to a differential CQI between the CQI determined based on the aggregation of the precoding matrix corresponding to the first PMI component and the differential precoding matrix corresponding to the second PMI component and the first CQI component.

12. The UE of claim 7, wherein the first PMI component is transmitted once for N transmissions of the second PMI component.

13. A method performed by a base station in a communication system, the method comprising:
transmitting first configuration information associated with codebook-based precoding matrix indicator (PMI) determination and second configuration information associated with artificial intelligence/machine learning (AI/ML)-based PMI determination;
receiving a first PMI component associated with the first configuration information; and
receiving a second PMI component associated with the second configuration information and an AI/ML model configured for the AI/ML-based PMI determination,
wherein the second PMI component corresponds to a differential precoding matrix with respect to a precoding matrix corresponding to the first PMI component.

14. The method of claim 13,
wherein the first PMI component is based on a number of ports for the first PMI component and the second PMI component is determined based on a number of ports for the second PMI component, and
wherein:
the number of ports for the first PMI component is indicated based on the first configuration information, and the number of ports for the second PMI component is indicated based on the number of ports for the first PMI component and a port scaling factor to scale the number of ports for the first PMI component, wherein the port scaling factor is configured based on the second configuration information, or
(i) in case that the number of ports for the second PMI component is explicitly configured based on the second configuration information, the number of ports for the second PMI component is the configured number, and in case that the number of ports for the second PMI component is not explicitly configured, the number of ports for the second PMI component is identical to a number of ports for channel state information (CSI) reference signal, and (ii) the number of ports for the first PMI component is indicated based on a bitmap based port indicator to indicate ports for the first PMI component among the number of ports for the second PMI component, wherein the bitmap based port indicator is configured based on the first configuration information.

15. The method of claim 13,
wherein the first PMI component is based on a first number of subbands and the second PMI component is based on a second number of subbands, and
wherein:
the number of subbands for the first PMI component is indicated based on the first configuration information, and the number of subbands for the second PMI component is indicated based on the number of subbands for the first PMI component and a subband scaling factor to scale the number of subbands for the first PMI component, wherein the subband scaling factor is configured based on the second configuration information, or
the number of subbands for the second PMI component is indicated based on the second configuration information, and the number of subbands for the first PMI component is indicated based on a bitmap based subband indicator to indicate subbands for the first PMI component among the subbands for the CSI reference signal, wherein the bitmap based subband indicator is configured based on the first configuration information.

16. The method of claim 13,
wherein information on first combining coefficients corresponding to the first PMI component is received with the first PMI component and information on second combining coefficients corresponding to the second PMI component is received with the second PMI component,
wherein the first combining coefficients are based on the first configuration information and the second combining coefficients are based on the second configuration information and the AI/ML model, and
wherein the second combining coefficients correspond to delta values with respect to the first combining coefficients.

17. A base station in a communication system, the base station comprising:
a transceiver; and
a processor coupled with the transceiver and configured to:
transmit first configuration information associated with codebook-based precoding matrix indicator (PMI) determination and second configuration information associated with artificial intelligence/machine learning (AI/ML)-based PMI determination,
receive a first PMI component associated with the first configuration information, and
receive a second PMI component associated with the second configuration information and an AI/ML model configured for the AI/ML-based PMI determination,
wherein the second PMI component corresponds to a differential precoding matrix with respect to a precoding matrix corresponding to the first PMI component.

18. The base station of claim 17,
wherein the first PMI component is based on a number of ports for the first PMI component and the second PMI component is determined based on a number of ports for the second PMI component, and
wherein:
the number of ports for the first PMI component is indicated based on the first configuration information, and the number of ports for the second PMI component is indicated based on the number of ports for the first PMI component and a port scaling factor to scale the number of ports for the first PMI component, wherein the port scaling factor is configured based on the second configuration information, or
(i) in case that the number of ports for the second PMI component is explicitly configured based on the second configuration information, the number of ports for the second PMI component is the configured number, and in case that the number of ports for the second PMI component is not explicitly configured, the number of ports for the second PMI component is identical to a number of ports for channel state information (CSI) reference signal, and (ii) the number of ports for the first PMI component is indicated based on a bitmap based port indicator to indicate ports for the first PMI component among the number of ports for the second PMI component, wherein the bitmap based port indicator is configured based on the first configuration information.

19. The base station of claim 17,
wherein the first PMI component is based on a first number of subbands and the second PMI component is based on a second number of subbands,
wherein:
the number of subbands for the first PMI component is indicated based on the first configuration information, and the number of subbands for the second PMI component is indicated based on the number of subbands for the first PMI component and a subband scaling factor to scale the number of subbands for the first PMI component, wherein the subband scaling factor is configured based on the second configuration information, or
the number of subbands for the second PMI component is indicated based on the second configuration information, and the number of subbands for the first PMI component is indicated based on a bitmap based subband indicator to indicate subbands for the first PMI component among the subbands for the CSI reference signal, wherein the bitmap based subband indicator is configured based on the first configuration information.

20. The base station of claim 17,
wherein information on first combining coefficients corresponding to the first PMI component is received with the first PMI component and information on second combining coefficients corresponding to the second PMI component is received with the second PMI component,
wherein the first combining coefficients are based on the first configuration information and the second combining coefficients are based on the second configuration information and the AI/ML model, and
wherein the second combining coefficients correspond to delta values with respect to the first combining coefficients.
